(19) United States
(12) Patent Application Publication
(10) Pub. No.: US 2022/0363822 A1
(43) Pub. Date: Nov. 17, 2022

(54) CRYSTALLIZABLE SHRINKABLE FILMS AND THERMOFORMABLE FILMS AND SHEETS MADE FROM REACTOR GRADE RESINS WITH RECYCLED CONTENT

(71) Applicant: Eastman Chemical Company, Kingsport, TN (US)

(72) Inventors: Mark Allen Peters, Jonesborough, TN (US); Jonathan Michael Horton, Kingsport, TN (US); Travis Wynne Keever, Gray, TN (US); Michael Paul Ekart, Kingsport, TN (US); Erin G. Ekart, Gray, TN (US)

(73) Assignee: Eastman Chemical Company, Kingsport, TN (US)

(21) Appl. No.: 17/755,098

(22) PCT Filed: Oct. 8, 2020
(86) PCT No.: PCT/US2020/054687

§ 371 Date: Apr. 21, 2022

Related U.S. Application Data
(60) Provisional application No. 62/925,887, filed on Oct. 25, 2019.
(60) Provisional application No. 62/925,882, filed on Oct. 25, 2019.

(51) Int. Cl. C08G 63/91; C08G 63/89; C08G 63/86; C08J 5/18

(52) U.S. Cl. CPC C08G 63/916; C08G 63/89; C08G 63/866; C08J 5/18; C08G 2250/00; C08J 2367/02

(57) ABSTRACT

The present disclosure relates to crystallizable shrinkable films and thermoformable films or sheets comprising amorphous polyester compositions which comprise residues of terephthalic acid, neopentyl glycol (NRG), 1,4-cyclohexanedimethanol CHDM), ethylene glycol (EG), and diethylene glycol (DEG), in certain compositional ranges having certain advantages and improved properties. The present disclosure also relates to crystallizable shrinkable films and thermoformable film(s) and/or sheet(s) comprising polyester compositions which comprise residues of recycled terephthalic acid, recycled neopentyl glycol (NRG), recycled 1,4-cyclohexanedimethanol (CHDM), recycled ethylene glycol (EG), and recycled diethylene glycol (DEG), in certain compositional ranges having certain advantages and improved properties.

### FIELD OF THE INVENTION

The present disclosure relates to crystallizable shrinkable films and thermoformable film(s) and/or sheet(s) comprising polyester compositions which comprise residues of terephthalic acid, neopentyl glycol (NPG), 1,4-cyclohexanedimethanol (CHDM), ethylene glycol (EG), and diethylene glycol (DEG), in certain compositional ranges having certain advantages and improved properties. The present disclosure further relates to crystallizable shrinkable films and thermoformable film(s) and/or sheet(s) comprising polyester compositions which comprise residues of recycled terephthalic acid, recycled neopentyl glycol (NPG), recycled 1,4-cyclohexanedimethanol (CHDM), recycled ethylene glycol (EG), and recycled diethylene glycol (DEG), in certain compositional ranges having certain advantages and improved properties.

### BACKGROUND OF THE INVENTION

There is a commercial need for shrink films that have at least one of the following desirable shrink film properties: (1) low onset shrinkage temperature, (2) a shrinkage percentage which increases gradually and in a controlled manner with increasing temperature over the temperature range where shrinkage occurs, (3) a shrink force low enough to prevent crushing of the underlying container, (4) a high ultimate shrinkage (shrinkage at the highest temperature), e.g. 60% or greater shrinkage in the main shrinkage direction at 95° C., (5) low shrinkage in the direction orthogonal to the high shrinkage direction, (6) improved film toughness so as to prevent unnecessary fracturing, breaking, tearing, splitting, bubbling, or wrinkling of the film during manufacture and prior to and after shrinkage, (7) recyclability, and (8) recycled content.

There is a commercial need for thermoformable films or sheet with good film or sheet properties and recyclability and/or recycled content.

### BRIEF SUMMARY OF THE INVENTION

It has been found that certain combinations of glycol monomers in a shrink film resin composition can produce a film with good shrink film performance and also be crystallizable such that it does not impact the recycling of the PET flake during recycling. These crystallizable shrink film resins can be processed with the PET bottle and end up as a component in the recyclable PET flake leaving the recycling process. It has also been found that the choice and quantity of specific combinations of glycol monomers are important to produce films with good shrink film properties and to produce a film that is crystallizable. The optimized polyester resin compositions of this disclosure are amorphous but crystallizable. As such, they exhibit good properties in film application including as shrink films, but they have high strain induced crystalline melting points, so they provide compatibility in recycling processes. The shrink film labels of the present disclosure do not have to be removed during the recycle process, and they do not impact the process.

Thermoshrinkable films must meet a variety of fitness for use criteria to perform in this application. The films must be tough, must shrink in a controlled manner, and must provide enough shrink force to hold itself on the bottle without crushing the contents. In addition, when these labels are applied to polyester containers, polyester shrink film labels must not interfere with the recycling process of the bottle. The shrink films of the present disclosure are advantageous because the label can be recycled with the bottle or container. As such, the entire bottle, including the label, can be recycled and converted into new products without creating additional handling requirements or creating new environmental issues. Thermoshrinkable films have been made from a variety of raw materials to meet a range of material demands. This disclosure describes unique and unexpected effects measured with certain monomers combinations for shrink film resin compositions.

Polyester shrink film compositions have been used commercially as shrink film labels for food, beverage, personal care, household goods, etc. Often, these shrink films are used in combination with a clear polyethylene terephthalate (PET) bottle or container. The total package (bottle plus label) is then placed in the recycling process. In a typical recycling center, the PET and the shrink film material often end up together at the end of the process due to similarities in composition and density. Drying of the PET flake is required to remove residual water that remains with the PET through the recycling process. Typically, PET is dried at temperatures above 200° C. At those temperatures, typical polyester shrink film resins will soften and become sticky, often creating clumps with PET flakes. These clumps must be removed before further processing. These clumps reduce the yield of PET flake from the process and create an additional handling step.

Also, it has been found that certain combinations of glycol monomers in a film or sheet resin composition can produce film or sheet with good performance properties and is also crystallizable such that it does not impact the recycling of the PET flake. These crystallizable film or sheet resins can be processed with recycled PET and end up as a component in the recyclable PET flake leaving the recycling process. It has also been found that the choice and quantity of specific combinations of glycol monomers are important to produce films or sheet with good performance properties and to produce a film or sheet that is crystallizable. The optimized polyester resin compositions of this disclosure are amorphous but crystallizable. As such, they exhibit good properties in film or sheet applications including as molded, thermoformed, or shaped parts and/or articles, but they have high strain induced crystalline melting points, so they can be recycled with PET. The films or sheet of the present disclosure do not have to be removed during the recycle process, and they do not impact the recycle process.

One embodiment of the present disclosure is a crystallizable film comprising an amorphous polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 0 to less than about 24 mole % neopentyl glycol residues; (ii) about 0 to less than about 24 mole % 1,4-cyclohexanedimethanol residues; (iii) about 1 to less than about 10 mole % total diethylene glycol residues in the final polyester composition; wherein the total mole % of the dicarboxylic acid component is 100 mole %, and wherein the total mole % of the diol component is 100 mole %; or (b) a diol component comprising: about 75 mole % or greater of ethylene glycol residues and about 25 mole % or less of other glycols comprising one or more of: (i) about 0.1 to less than about 24 mole % neopentyl glycol residues; (ii) about 0.1 to less than about 24 mole % 1,4-cyclohexanedimethanol residues; (iii) about 1 to less than about 10 mole % total diethylene glycol residues in the final polyester composition; wherein the total mole % of the dicarboxylic acid component is 100 mole %, and wherein the total mole % of the diol component is 100 mole %.

One embodiment of the present disclosure is a crystallizable film comprising an amorphous polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 15 mole % or less of neopentyl glycol residues; (ii) about 5 mole % or less of 1,4-cyclohexanedimethanol residues; (iii) about 5 mole % or less of total diethylene glycol residues in the final polyester composition; wherein the total mole % of the dicarboxylic acid component is 100 mole %, and wherein the total mole % of the diol component is 100 mole %.

One embodiment of the present disclosure is a crystallizable film comprising an amorphous polyester composition comprising: at least one polyester which comprises:(a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 80 mole % or greater of ethylene glycol residues and about 20 mole % or less of other glycols comprising one or more of: (i) about 5 to less than about 17 mole % neopentyl glycol residues; (ii) about 2 to less than about 10 mole % 1,4-cyclohexanedimethanol residues; (iii) about 1 to less than about 5 mole % total diethylene glycol residues in the final polyester composition; wherein the total mole % of the dicarboxylic acid component is 100 mole %, and wherein the total mole % of the diol component is 100 mole %.

One embodiment of the present disclosure is a crystallizable film comprising an amorphous polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 76 mole % or greater of ethylene glycol residues and about 24 mole % or less of amorphous content comprising one or more of: (i) neopentyl glycol residues; (ii) cyclohexanedimethanol residues; and (iii) diethylene glycol residues in the final polyester composition; wherein the total mole % of the dicarboxylic acid component is 100 mole %, and wherein the total mole % of the diol component is 100 mole %.

One embodiment of the present disclosure is a crystallizable film comprising an amorphous polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 10 to less than about 15 mole % neopentyl glycol residues; (ii) about 1 to less than about 5 mole % 1,4-cyclohexanedimethanol residues; (iii) about 1 to less than about 5 mole % total diethylene glycol residues in the final polyester composition; wherein the total mole % of the dicarboxylic acid component is 100 mole %, and wherein the total mole % of the diol component is 100 mole %.

One embodiment of the present disclosure is a crystallizable film comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: (i) about 0 to about 30 mole % neopentyl glycol residues; (ii) about 0 to about less than 30 mole % 1,4-cyclohexanedimethanol residues; (iii) residues of diethylene glycol, whether or not formed in situ; and wherein the remainder of the glycol component comprises: (iv) residues of ethylene glycol, and (v) optionally 0 to 10 mole %, or 0 to 5 mole % of the residues of at least one modifying glycol; wherein the total mole % of the dicarboxylic acid component is 100 mole %, and wherein the total mole % of the glycol component is 100 mole %.

One embodiment of the present disclosure is a crystallizable film of any of the preceding embodiments, wherein the film is stretched in at least one direction and the stretched film has a strain induced crystalline melting point of 190° C. or greater or of 200° C. or greater.

One embodiment of the present disclosure is an extruded or calendared film comprising a crystallizable film of any of the preceding embodiments.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 0 to less than about 24 mole % neopentyl glycol residues; (ii) about 0 to less than about 24 mole % 1,4-cyclohexanedimethanol residues; (iii) about 1 to less than about 10 mole % total diethylene glycol residues in the final polyester composition; wherein the total mole % of the dicarboxylic acid component is 100 mole %, and wherein the total mole % of the diol component is 100 mole %; or (b) a diol component comprising: about 75 mole % or greater of ethylene glycol residues and about 25 mole % or less of other glycols comprising one or more of: (i) about 0.1 to less than about 24 mole % neopentyl glycol residues; (ii) about 0.1 to less than about 24 mole % 1,4-cyclohexanedimethanol residues; (iii) about 1 to less than about 10 mole % total diethylene glycol residues in the final polyester composition; wherein the total mole % of the dicarboxylic acid component is 100 mole %, and wherein the total mole % of the diol component is 100 mole %.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 15 mole % or less of neopentyl glycol residues; (ii) about 5 mole % or less of 1,4-cyclohexanedimethanol residues; (iii) about 5 mole % or less of total diethylene glycol residues in the final polyester composition; wherein the total mole % of the dicarboxylic acid component is 100 mole %, and wherein the total mole % of the diol component is 100 mole %.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 80 mole % or greater of ethylene glycol residues and about 20 mole % or less of other glycols comprising one or more of: (i) about 5 to less than about 17 mole % neopentyl glycol residues; (ii) about 2 to less than about 10 mole % 1,4-cyclohexanedimethanol residues; (iii) about 1 to less than about 5 mole % total diethylene glycol residues in the final polyester composition; wherein the total mole % of the dicarboxylic acid component is 100 mole %, and wherein the total mole % of the diol component is 100 mole %.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 76 mole % or greater of ethylene glycol residues and about 24 mole % or less of amorphous content comprising one or more of: (i) neopentyl glycol residues; (ii) cyclohexanedimethanol residues; and (iii) diethylene glycol residues in the final polyester composition; wherein the total mole % of the dicarboxylic acid component is 100 mole %, and wherein the total mole % of the diol component is 100 mole %.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: about 75 mole % or greater of ethylene glycol residues and about 25 mole % or less of other glycols comprising one or more of: (i) about 10 to less than about 15 mole % neopentyl glycol residues; (ii) about 1 to less than about 5 mole % 1,4-cyclohexanedimethanol residues; (iii) about 1 to less than about 5 mole % total diethylene glycol residues in the final polyester composition; wherein the total mole % of the dicarboxylic acid component is 100 mole %, and wherein the total mole % of the diol component is 100 mole %.

One embodiment of the present disclosure is a thermoformed film or sheet comprising a polyester composition comprising: at least one polyester which comprises: (a) a dicarboxylic acid component comprising: (i) about 70 to about 100 mole % of terephthalic acid residues; (ii) about 0 to about 30 mole % of aromatic and/or aliphatic dicarboxylic acid residues having up to 20 carbon atoms; and (b) a diol component comprising: (i) about 0 to about 30 mole % neopentyl glycol residues; (ii) about 0 to about less than 30 mole % 1,4-cyclohexanedimethanol residues; (iii) residues of diethylene glycol, whether or not formed in situ; and wherein the remainder of the glycol component comprises: (iv) residues of ethylene glycol, and (v) optionally 0 to 10 mole %, or 0 to 5 mole % of the residues of at least one modifying glycol; wherein the total mole % of the dicarboxylic acid component is 100 mole %, and wherein the total mole % of the glycol component is 100 mole %.

One embodiment of the present disclosure is a molded, thermoformed, or shaped article comprising the film or sheet of any of the preceding embodiments.

One embodiments of the present disclosure is a medical device, medical packaging, healthcare supplies, commercial foodservice products, trays, containers, food pans, tumblers, storage boxes, bottles, food processors, blender and mixer bowls, utensils, water bottles, crisper trays, washing machine parts, refrigerator parts, vacuum cleaner parts, ophthalmic lenses and frames or toys comprising the thermoformed film or sheet of any of the preceding embodiments.

One embodiment of the present disclosure is an article of manufacture comprising the thermoformed film or sheet of any of the preceding claims.

One embodiment of the present disclosure is a method of making the thermoformed film or sheet of any of the preceding embodiments comprising: A. heating the polyester film or sheet; B. applying air pressure, vacuum and/or physical pressure to the heat softened film or sheet; C. conforming the sheet by vacuum or pressure to a mold shape; and D. removing the thermoformed part or article from the mold.

One aspect of the present disclosure is a process for preparing the polyesters of the present disclosure from recycled polyesters. One aspect of the present disclosure is a process for preparing copolyesters from recycled polyesters and/or recycled copolyesters

In one aspect, the present disclosure provides a process for preparing linear, high molecular weight copolyesters from either (A) recycled polyesters and/or recycled copolyesters, the acid component of which consists of at least 70 mole percent terephthalic acid and the diol component of which consists of at least 70 mole percent ethylene glycol or (B) recycled copolyesters, the acid component of which consists of at least 70 mole percent terephthalic acid and the diol component of which consists of at least 70 mole percent of a mixture of ethylene glycol, 1,4-cyclohexanedimethanol, and diethylene glycol in a mole ratio of from 96:3:1 to 20:68:12, or (C) recycled copolyesters, the acid component of which consists of at least 70 mole percent terephthalic acid and the diol component of which consists of at least 70 mole percent of a mixture of 2 or more glycols comprising ethylene glycol (EG), diethylene glycol (DEG), 1,4-cyclohexanedimethanol (CHDM), neopentyl glycol (NPG), or 2,2,4,4-tetramethyl-1,3-cyclobutanediol (TMCD)), butanediol, and isosorbide or (D) recycled copolyesters, the acid component of which consists of at least 70 mole percent terephthalic acid and the diol component of which consists of at least 70 mole percent of a mixture of ethylene glycol, 1,4-cyclohexanedimethanol in a mole ratio of from 3.5:96.5 to 100:0.

The process provides a fast polymerization rate and the polymers so produced can be used in the manufacture of plastics, fibers, films, shrinkable films, sheet, molded articles and other shaped objects having good physical properties. In one aspect, the disclosed process describes a method for converting post-industrial and post-consumer waste products into high quality copolyester resins capable of being used to make new plastics with a high level of recycle content. In another aspect, the disclosed process describes a method for converting post-industrial and post-consumer waste products into resins capable of being used to make high quality shrinkable films.

One aspect of the present disclosure is a process for producing a copolyester from recycled copolyesters comprising:
(a) introducing recycled PET, recycled PETG, recycled PCT, recycled PCTG, recycled PCTA, recycled PCTM and/or recycled PETM; terephthalic acid (TPA); and ethylene glycol (EG) into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG), or 2,2,4,4-tetramethyl-1,3-cyclobutanediol (TMCD), and optionally adding additional recycled PET, recycled PETG, recycled PCTM and/or recycled PETM; terephthalic acid (TPA); and ethylene glycol (EG) at an EG:TPA molar ratio of 1:1 to 4:1 into the first reaction zone, and optionally a catalyst;
(d) reacting TPA with EG and the at least one additional glycol (such as CHDM) in the first reaction zone at a melt temperature of at least 200° C. and a pressure of up to 40 psi to form a first esterification product comprising oligomers and unreacted TPA, EG, and the additional glycol (such as CHDM);
(e) passing the first esterification product to a second reaction zone;
(f) esterifying the unreacted TPA, EG, and the additional glycol (such as CHDM) in the first esterification product in the second reaction zone at a melt temperature of at least 200° C. and a pressure of up to 20 psi to form a second esterification product comprising copolyester oligomers;
(g) passing the second esterification product to a third reaction zone;
(h) polycondensing the second esterification product in the third reaction zone to form a prepolymerization product comprising copolyesters, optionally in the presence of a polycondensation catalyst; and
(i) passing the prepolymerization product to one or more finishing zones.

One aspect of the present disclosure is a process for producing a copolyester from recycled copolyesters comprising:
(a) introducing recycled PET, recycled PETG, recycled PCT, recycled PCTG or recycled PCTA; terephthalic acid (TPA); and ethylene glycol (EG) into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), DEG, or neopentyl glycol (NPG), and optionally adding additional recycled PET, recycled PETG, recycled PCT, recycled PCTG or recycled PCTA; and terephthalic acid (TPA); and ethylene glycol (EG) at an EG:TPA molar ratio of 1:1 to 4:1 into the first reaction zone, optionally in the presence of an esterification catalyst;
(d) reacting TPA with EG and the at least one additional glycol (such as CHDM) in the first reaction zone at a melt temperature of at least 200° C. and a pressure of up to 40 psi to form a first esterification product comprising oligomers and unreacted TPA, EG, and the additional glycol (such as CHDM and/or NPG and/or DEG);
(e) passing the first esterification product to a second reaction zone;
(f) esterifying the unreacted TPA, EG, and the additional glycol (such as CHDM) in the first esterification product in the second reaction zone at a melt temperature of at least 200° C. and a pressure of up to 20 psi to form a second esterification product comprising copolyester oligomers;
(g) passing the second esterification product to a third reaction zone;
(h) polycondensing the second esterification product in the third reaction zone to form a prepolymerization product comprising copolyesters, optionally in the presence of a polycondensation catalyst; and
(i) passing the prepolymerization product to one or more finishing zones.

One aspect of the present disclosure, is the process of any one of the previous aspects, wherein the process further comprises adding a catalyst or additive via the addition of recycled polyester in which the catalyst or additive is a component of the recycled polyester; such as Sb, Ti, Co, Mn, Li, Al, P.

One aspect of the present disclosure is a method of introducing or establishing recycle content in a polyester produced by the process of the previous aspects comprising:

a. obtaining a recycled monomer allocation or credit for at least one recycled monomer comprising TPA, EG, DMT, CHDM, NPG or DEG;
b. converting the recycled monomers in a synthetic process to make a polyester;
c. designating at least a portion of the polyester as corresponding to at least a portion of the recycled monomer allocation or credit; and
d. optionally, offering to sell or selling the polyester as containing or obtained with recycled monomer content corresponding with such designation.

### BRIEF DESCRIPTION OF THE DRAWINGS

FIG. 1: Differential Scanning calorimeter Thermogram showing 1^{st} Heat Strain Induced Crystalline Melting point for Embrace LV.

FIG. 2: Shrinkage Properties of a Film Made with Embrace LV (10 second dwell time).

FIG. 3: Shrinkage Performance.

FIG. 4: DSC Thermogram of Film N, stretched at 80° C. 1st Heat.

FIG. 5: DSC Thermogram of Film N, stretched at 80° C. 2nd Heat.

FIG. 6 is a flow diagram of various processes according to the present disclosure.

FIG. 7. Sb catalyst levels in the final material as a function of rPET starting material loading level.

### DETAILED DESCRIPTION

The present disclosure may be understood more readily by reference to the following detailed description of certain embodiments of the disclosure and the working examples. In accordance with the purpose(s) of this disclosure, certain embodiments of the disclosure are described in the Summary of the Invention and are further described herein below. Also, other embodiments of the disclosure are described herein.

Heat-shrinkable plastic films are used as coverings, to hold objects together, and as an outer wrapping for bottles, cans and other kinds of containers. For example, such films are used for covering the cap, neck, shoulder or bulge of bottles or the entire bottle; for the purpose of labeling, protection, parceling, or increasing the value of the product; and for other reasons. In addition, such films may be used as a covering to package such objects as boxes, bottles, boards, rods, or notebooks together in groups, and such films may also be attached closely as a wrapping. The uses mentioned above take advantage of the shrinkability and the internal shrink stress of the film.

Historically, Poly(vinyl chloride) (PVC) films dominated the shrink film market. However, polyester films have become a significant alternative because polyester films do not possess the environmental problems associated with PVC films. Polyester shrink films ideally would have properties very similar to PVC films so that the polyester films can serve as a “drop-in” replacement films and can be processed in existing shrink tunnel equipment. PVC film properties that are desired for duplication include the following: (1) a relatively low shrinkage onset temperature, (2) a total shrinkage which increases gradually and in a controlled manner with increasing temperature, (3) a low shrink force to prevent crushing of the underlying container, (4) a high total shrinkage (for example, 50% or greater), (5) an inherent film toughness so as to prevent unnecessary tearing and splitting of the film prior to and after shrinkage, and (6) a high strain induced crystalline melt temperature.

Thermoshrinkable films much meet a variety of fitness for use criteria in order to perform in this application. The films must be tough, must shrink in a controlled manner, and must provide enough shrink force to hold itself on the bottle without crushing the contents. In addition, when these labels are applied to polyester containers, they must not interfere with the recycling process for the PET bottle. In fact, it would be advantageous, if the label was also recyclable so the entire bottle can be recycled and converted into new products without creating additional handling requirements or create new environmental issues. Thermoshrinkable films have been made from a variety of raw materials to meet a range of material demands. This disclosure describes unique and unexpected effects measured with certain monomers combinations that improves the recyclability of the polyester shrink film label.

Shrink film compositions are used commercially as shrink film labels for food, beverage, personal care, household goods, etc. Often, these shrink films are used in combination with a clear polyethylene terephthalate (PET) bottle or container. The total package (bottle plus label) is then placed in the recycling process. In a typical recycling center, the PET and the shrink film material often end up together at the end of the process due to similarities in composition and density. Drying of the PET flake is required to remove residual water that remains with the PET through the recycling process. Typically, PET is dried at temperatures above 200° C. At those temperatures, typical polyester shrink film resins will soften and become sticky, often creating clumps with PET flakes. These clumps must be removed before further processing. These clumps reduce the yield of PET flake from the process and create an additional handling step.

It has been found that certain combinations of glycol monomers in a shrink film resin composition can produce a film with good shrink film performance and also be crystallizable such that it does not impact the recycling of the PET flake during recycling. These crystallizable shrink film resins can be processed with the PET bottle and end up as a component in the recyclable PET flake leaving the recycling process. It has also been found that the choice and quantity of specific combinations of glycol monomers are important to produce films with good shrink film properties and to produce a film that is crystallizable.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid, for example, p-hydroxybenzoic acid, and the difunctional hydroxyl compound may have an aromatic nucleus bearing 2 hydroxyl substituents, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present disclosure typically can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % 1,4-cyclohexanedimethanol, based on the total diol residues, means the polyester contains 25 mole % 1,4-cyclohexanedimethanol residues out of a total of 100 mole % diol residues. Thus, there are 25 moles of 1,4-cyclohexanedimethanol residues among every 100 moles of diol residues.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present disclosure. In embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the polyesters useful in the present disclosure can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present disclosure include but are not limited to those having up to 20 carbon atoms, and which can be linear, para-oriented, or symmetrical. Examples of modifying aromatic dicarboxylic acids which may be used in this disclosure include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the present disclosure can be further modified with up to 10 mole %, such as up to 5 mole % or up to 1 mole % of one or more aliphatic dicarboxylic acids containing 2-16 carbon atoms, for example, cyclohexanedicarboxylic, malonic, succinic, glutaric, adipic, pimelic, suberic, azelaic and/or dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the polyesters and are useful in the present disclosure.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the diol component of the polyester compositions and the polyester blend compositions useful in the present disclosure can comprise 1,4-cyclohexanedimethanol. In another embodiment, the diol component of the polyester compositions and the polyester blend compositions useful in the present disclosure comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

The diol component of the polyester compositions and the polyester blend compositions useful in the present disclosure can include, but is not limited to, compositions wherein the sum of the residues of 1,4-cyclohexanedimethanol and residues of neopentyl glycol in the final polyester composition is from 0 to 30 mole %, or from 1 to 30 mole %, or from 1 to 25 mole %, 1 to 20 mole %, or from 1 to 15 mole %, or from 1 to 10 mole %, or from 2 to 30 mole %, or from 2 to 25 mole %, or from 2 to 20 mole %, or from 2 to 15 mole %, or from 2 to 10 mole %, or from 3 to 30 mole %, or from 3 to 25 mole %, or from 3 to 20 mole %, or from 3 to 15 mole %, or from 3 to 10 mole %, 4 to 30 mole %, or from 4 to 25 mole %, 4 to 20 mole %, or from 4 to 15 mole %, or from 4 to 10 mole %, 5 to 30 mole %, or from 5 to 25 mole %, 5 to 20 mole %, or from 5 to 15 mole %, or from 5 to 10 mole %, 6 to 30 mole %, or from 6 to 25 mole %, 6 to 20 mole %, or from 6 to 15 mole %, or from 6 to 10 mole %, 7 to 30 mole %, or from 7 to 25 mole %, 7 to 20 mole %, or from 7 to 15 mole %, or from 7 to 10 mole %, 8 to 30 mole %, or from 8 to 25 mole %, 8 to 20 mole %, or from 8 to 15 mole %, or from 8 to 10 mole %, 9 to 30 mole %, or from 9 to 25 mole %, 9 to 20 mole %, or from 9 to 15 mole %, or from 9 to 10 mole/0,10 to 30 mole %, or from 10 to 25 mole %, 10 to 20 mole %, or from 10 to 15 mole %, or from 11 to 30 mole %, 11 to 30 mole %, or from 11 to 25 mole %, 11 to 20 mole %, or from 11 to 15 mole %, or from 12 to 30 mole/0,12 to 25 mole %, or from 12 to 20 mole %, 12 to 15 mole %, or from 13 to 30 mole %, or from 13 to 25 mole/0,13 to 20 mole %, or from 13 to 15 mole %, 14 to 30 mole %, or from 14 to 25 mole %, or from 14 to 20 mole %, 14 to 15 mole %, or from 15 to 30 mole %, 15 to 25 mole %, or from 15 to 20 mole %, or from 16 to 20 mole %, 18 to 20 mole %, or from 10 to 18 mole %, 16 to 18 mole %, or from 12 to 16 mole %, or from 16 to 20 mole %, or from 14 to 18 mole %, or from 11 to 30 mole %, or from 13 to 30 mole %, or from 14 to 30 mole %, or from 10 to 29 mole %, or from 11 to 29 mole %, or from 12 to 29 mole %, or from 13 to 29 mole %, or from 14 to 29 mole %, or from 15 to 29 mole %, or from 10 to 28 mole %, or from 11 to 28 mole %, or from 12 to 28 mole %, or from 13 to 28 mole %, or from 14 to 28 mole %, or from 15 to 28 mole %. In one embodiment, the sum of residues of 1,4-cyclohexanedimethanol and residues of neopentyl glycol in the final polyester composition can be from 4 to 15 mole %, or from 2 to 21 mole %, or from 2 to less than 20 mole %, or from 4 to 20 mole %, or from 5 to 18 mole %, or from 10 to 21 mole %, or from 12 to 21 mole %, wherein the total mole % of the diol component is 100 mole %.

In one embodiment, the diol component of the polyester compositions and polyester blend compositions useful in this disclosure can contain 0 to 30 mole % of neopentyl glycol based on the total mole % of the diol component being 100 mole %. In one embodiment, the diol component of the polyester compositions and the polyester blend compositions useful in this disclosure can contain 0 to 25 mole % of neopentyl glycol based on the total mole % of the diol component being 100 mole %. In one embodiment, the diol component of the polyester compositions and polyester blend compositions useful in this disclosure can contain 0 to 17 mole % of neopentyl glycol based on the total mole % of the diol component being 100 mole %. In one embodiment, the diol component of the polyester compositions and polyester blend compositions useful in this disclosure can contain 5 to 20 mole % of neopentyl glycol based on the total mole % of the diol component being 100 mole %. In one embodiment, the diol component of the polyester compositions and polyester blend compositions useful in this disclosure can contain 10 to 20 mole % of neopentyl glycol based on the total mole % of the diol component being 100 mole %. In one embodiment, the diol component of the polyester compositions and polyester blend compositions useful in this disclosure can contain 10 to 15 mole % of neopentyl glycol based on the total mole % of the diol component being 100 mole %. In one embodiment, the diol component of the polyester compositions and polyester blend compositions useful in this disclosure can contain 15 to 25 mole % of neopentyl glycol based on the total mole % of the diol component being 100 mole %.

In one embodiment, the diol component of the polyester compositions and polyester blend compositions useful in the present disclosure can contain from 0 to 30 mole %, or from 0.01 to 30 mole %, or from 0 to 20 mole %, or from 0.1 to 20 mole %, or from 2 to 20 mole %, or from 0.01 to 15 mole %, or from 0.01 to 14 mole %, or from 0.01 to 13 mole %, or from 0.01 to 12 mole %, or from 0.01 to 11 mole %, or 0.01 to 10 mole %, or from 0.01 to 9 mole %, or from 0.01 to 8 mole %, or from 0.01 to 7 mole %, or from 0.01 to 6 mole %, or from 0.01 to 5 mole %, 3 to 15 mole %, or from 3 to 14 mole %, or from 3 to 13 mole %, or from 3 to 12 mole %, or from 3 to 11 mole %, or 3 to 10 mole %, or from 3 to 9 mole %, or from 3 to 8 mole %, or from 3 to 7 mole %, or from 2 to 10 mole %, or from 2 to 9 mole %, or from 2 to 8 mole %, or from 2 to 7 mole %, or from 2 to 5 mole %, or from 1 to 7 mole %, or from 1 to 5 mole %, or from 1 to 3 mole %, of 1,4-cyclohexanedimethanol residues, based on the total mole % of the diol component being 100 mole %.

In one embodiment, the diol component of the polyester compositions useful in the present disclosure can contain 0.01 to 15 mole % of 1,4-cyclohexanedimethanol based on the total mole % of the diol component being 100 mole %. In one embodiment, the diol component of the polyester compositions useful in this disclosure can contain 0 to less than 15 mole % of 1,4-cyclohexanedimethanol based on the total mole % of the diol component being 100 mole %. In one embodiment, the diol component of the polyester compositions useful in this disclosure can contain 0.01 to 10 mole % of 1,4-cyclohexanedimethanol based on the total mole % of the diol component being 100 mole %. In one embodiment, the diol component of the polyester compositions useful in this disclosure can contain 0 to less than 10 mole % of 1,4-cyclohexanedimethanol based on the total mole % of the diol component being 100 mole %. In one embodiment, the diol component of the polyester compositions useful in this disclosure can contain 0.01 to 5 mole % of 1,4-cyclohexanedimethanol based on the total mole % of the diol component being 100 mole %. In one embodiment, the diol component of the polyester compositions useful in this disclosure can contain 0 to less than 5 mole % of 1,4-cyclohexanedimethanol based on the total mole % of the diol component being 100 mole %.

It should be understood that some other diol residues may be formed in situ during processing. The total amount of diethylene glycol residues can be present in the polyester useful in the present disclosure, whether or not formed in situ during processing or intentionally added, or both, in any amount, for example, from 1 to 15 mole %, or from 2 to 12 mole %, or from 2 to 11 mole %, or 2 to 10 mole %, or from 2 to 9 mole %, or from 3 to 12 mole %, or from 3 to 11 mole %, or 3 to 10 mole %, or from 3 to 9 mole %, or from 4 to 12 mole %, or from 4 to 11 mole %, or 4 to 10 mole %, or from 4 to 9 mole %, or, from 5 to 12 mole %, or from 5 to 11 mole %, or 5 to 10 mole %, or from 5 to 9 mole %, of diethylene glycol residues, based on the total mole % of the diol component being 100 mole %.

In one embodiment, the total amount of diethylene glycol residues can be present in the polyester useful in the present disclosure, whether or not formed in situ during processing or intentionally added or both, can be from 4 mole % or less, or from 3.5 mole % or less, or from 3.0 mole % or less, or from 2.5 mole % or less, or from 2.0 mole % or less, or from 1.5 mole % or less, or from 1.0 mole % or less, or from 1 to 4 mole %, or from 1 to 3 mole %, or from 1 to 2 mole % of diethylene glycol residues, or from 2 to 8 mole %, or from 2 to 7 mole %, or from 2 to 6 mole %, or from 2 to 5 mole %, or from 3 to 8 mole %, or from 3 to 7 mole %, or from 3 to 6 mole %, or from 3 to 5 mole %, or in some embodiments there is no intentionally added diethylene glycol residues, based on the total mole % of the diol component being 100 mole %. In certain embodiments, the polyester contains no added modifying diols.

For all embodiments, the remainder of the diol component can comprise ethylene glycol residues in any amount based on the total mole % of the diol component being 100 mole %. In one embodiment, the polyester portion of the polyester compositions useful in the present disclosure can contain 50 mole % or greater, or 55 mole % or greater, or 60 mole % or greater, or 65 mole % or greater, or 70 mole % or greater, or 75 mole % or greater, or 80 mole % or greater, or 85 mole % or greater, or 90 mole % or greater, or 95 mole % or greater, or from 50 to 80 mole %, or from 55 to 80 mole %, or from 60 to 80 mole %, or from 50 to 75 mole %, or from 55 to 75 mole %, or from 60 to 75 mole %, or from 65 to 75 mole % of ethylene glycol residues, based on the total mole % of the diol component being 100 mole %.

In one embodiment, the diol component of the polyester compositions useful in the present disclosure can contain up to 20 mole %, or up to 19 mole %, or up to 18 mole %, or up to 17 mole %, or up to 16 mole %, or up to 15 mole %, or up to 14 mole %, or up to 13 mole %, or up to 12 mole %, or up to 11 mole %, or up to 10 mole %, or up to 9 mole %, or up to 8 mole %, or up to 7 mole %, or up to 6 mole %, or up to 5 mole %, or up to 4 mole %, or up to 3 mole %, or up to 2 mole %, or up to 1 mole %, or less of one or more modifying diols (modifying diols are defined as diols which are not ethylene glycol, diethylene glycol, neopentyl glycol, or 1,4-cyclohexanedimethanol). In certain embodiments, the polyesters useful in this disclosure can contain 10 mole % or less of one or more modifying diols. In certain embodiments, the polyesters useful in this disclosure can contain 5 mole % or less of one or more modifying diols. In certain embodiments, the polyesters useful in this disclosure can contain 3 mole % or less of one or more modifying diols. In another embodiment, the polyesters useful in this disclosure can contain 0 mole % modifying diols. It is contemplated, however, that some other diol residuals may form in situ so that residual amounts formed in situ are also an embodiment of this disclosure.

In embodiments, modifying diols for use in the polyesters, if used, as defined herein contain 2 to 16 carbon atoms. Examples of modifying diols include, but are not limited to, 1,2-propanediol, 1,3-propanediol, isosorbide, 1,4-butanediol, 1,5-pentanediol, 1,6-hexanediol, p-xylene glycol, polytetramethylene glycol, 2,2,4,4-tetramethyl-1,3-cyclobutanediol (TMCD) and mixtures thereof. In one embodiment, isosorbide is a modifying diol. In another embodiment, the modifying diols include, but are not limited to, at least one of 1,3-propanediol and 1,4-butanediol. In one embodiment, 1,3-propanediol and/or 1,4-butanediol can be excluded. If 1,4- or 1,3-butanediol are used, greater than 4 mole % or greater than 5 mole % can be provided in one embodiment. In one embodiment, at least one modifying diol is 1,4-butanediol which present in the amount of 5 to 25 mole %.

In one embodiment, a shrink film is provided comprising a polyester composition further comprising: 1,4-cyclohexanedimethanol residues are present in the amount of 0.01 to about 10 mole %, diethylene glycol residues are present in the amount of 2 to 9 mole %, neopentyl glycol residues in the amount of 5 to 30 mole %, and ethylene glycol residues are present in the amount of 60 mole % or greater, based on the total mole % of the diol component being 100 mole %.

In some embodiments, the polyesters according to the present disclosure can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present disclosure can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters useful in the present disclosure can comprise at least one chain extender. Suitable chain extenders include, but are not limited to, multifunctional (including, but not limited to, bifunctional) isocyanates, multifunctional epoxides, including, for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

It is contemplated that polyester compositions useful in the present disclosure can possess at least one of the inherent viscosity ranges described herein and at least one of the monomer ranges for the polyester compositions described herein, unless otherwise stated. It is also contemplated that polyester compositions useful in the present disclosure can possess at least one of the Tg ranges described herein and at least one of the monomer ranges for the polyester compositions described herein, unless otherwise stated. It is also contemplated that polyester compositions useful in the present disclosure can possess at least one of the inherent viscosity ranges described herein, at least one of the Tg ranges described herein, and at least one of the monomer ranges for the polyester compositions described herein, unless otherwise stated.

For embodiments of this disclosure, the polyesters useful in this disclosure can exhibit at least one of the following inherent viscosities as determined in 60/40 (wt/wt) phenol/tetrachloroethane at a concentration of 0.25 g/50 ml at 25° C.: 0.50 to 1.2 dL/g; 0.50 to 1.0 dL/g; 0.50 to 0.90 dL/g; 0.50 to 0.80 dL/g; 0.55 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; or 0.60 to 0.75 dL/g.

The glass transition temperature (Tg) of the polyesters is determined using a TA DSC 2920 from Thermal Analyst Instrument at a scan rate of 20° C./min.

In certain embodiments, the oriented films or shrink films of this disclosure comprise polyesters/polyester compositions wherein the polyester has a Tg of 60 to 80° C.; 70 to 80° C.; or 65 to 80° C.; or 65 to 75° C. In certain embodiments, these Tg ranges can be met with or without at least one plasticizer being added during polymerization.

In embodiments of the present disclosure, certain oriented films and/or shrinkable films comprising the polyesters and/or polyester compositions useful in this disclosure can have a unique combination of all of the following properties: good stretchability, controlled shrinkage properties, certain toughness, certain inherent viscosities, certain glass transition temperatures (Tg), certain strain induced crystalline melting points, certain flexural modulus, certain densities, certain tensile modulus, certain surface tension, good melt viscosity, good clarity, and good color.

In one embodiment, certain polyester compositions useful in this disclosure can be visually clear. The term “visually clear” is defined herein as an appreciable absence of cloudiness, haziness, and/or muddiness, when inspected visually.

The polyester portion of the polyester compositions useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the diol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the polyesters useful in the present disclosure, certain agents which colorize the polymer can be added to the melt including toners or dyes. In one embodiment, a bluing toner is added to the melt in order to reduce the b* of the resulting polyester polymer melt phase product. Such bluing agents include blue inorganic and organic toner(s) and/or dyes. In addition, red toner(s) and/or dyes can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The present disclosure further relates to polymer blends. In one embodiment, the polymer blend comprises:

(a) from 5 to 95 weight % of the polyester compositions of the disclosure described herein; and

(b) from 5 to 95 weight % of at least one polymeric component.

Suitable examples of the polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methyl methacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers. In one embodiment, aliphatic-aromatic polyesters can be excluded from the polyester compositions useful in this disclosure. The following polyesters, which can be blended to make the polyester compositions of this disclosure, can be excluded as the polymeric components used in additional blending if such blending exceeds the compositional ranges of the disclosure: polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester).

The blends can be prepared by conventional processing techniques known in the art, such as melt blending or solution blending.

In embodiments, the polyester compositions and the polymer blend compositions can also contain from 0.01 to 25% by weight of the overall composition common additives such as colorants, toner(s), dyes, mold release agents, flame retardants, plasticizers, glass bubbles, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

In one embodiment, the films and the shrink films according to the present disclosure may contain from 0.01 to 10 weight percent of the polyester plasticizer. In one embodiment, the shrink films can contain from 0.1 to 5 weight percent of the polyester plasticizer. Generally, the shrink films can contain from 90 to 99.99 weight percent of the copolyester. In certain embodiments, the shrink films can contain from 95 to 99.9 weight percent of the copolyester.

In one aspect, the present disclosure relates to shrink film(s) and molded article(s) of this disclosure comprising the polyester compositions and/or polymer blends useful in this disclosure. The methods of forming the polyesters and/or blends into film(s) and/or sheet(s) are well known in the art. Examples of film(s) and/or sheet(s) useful the present disclosure include but not are limited to extruded film(s) and/or sheet(s), compression molded film(s), calendered film(s) and/or sheet(s), solution casted film(s) and/or sheet(s). In one aspect, methods of making film and/or sheet useful to produce the shrink films of the present disclosure include but are not limited to extrusion, compression molding, calendering, and solution casting.

In one embodiment, the polyester compositions useful in this disclosure are made into film using any method known in the art to produce films from polyesters, for example, solution casting, extrusion, compression molding, or calendering.

In one embodiment, the as-formed film is then oriented in one or more directions (e.g., monoaxially and/or biaxially oriented film). This orientation of the film can be performed by any method known in the art using standard orientation conditions. For example, the oriented films of the disclosure can be made from films having a thickness of about 100 to 400 microns, for example, extruded, cast or calendered films, which can be oriented at a ratio of 5:1 to 3:1 at a temperature of from Tg to Tg+55° C. or from 70° C. to 125° C., for example, at a ratio of 5:1 or of 3:1 at a temperature from 100° C. to 114° C., and which can be oriented to a thickness of 20 to 80 microns. In one embodiment, the orientation of the initial pre-shrunk film can be performed on a tenter frame according to these orientation conditions.

The shrink films of the present disclosure can have an onset of shrinkage temperature of from about 55 to about 80° C., or about 55 to about 75° C., or about 55 to about 70° C. Shrink initiation temperature is the temperature at which the onset of shrinking occurs.

In certain embodiments, the polyester compositions useful in the present disclosure can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc.

In one embodiment, the density of the films is reduced by introducing many small voids or holes into the film or shaped article. This process is called “voiding” and may also be referred to as “cavitating” or “microvoiding”. Voids are obtained by incorporating about 1 to about 50 weight % of small organic or inorganic particles (including glass microspheres) or “inclusions” (referred in the art as “voiding” or “cavitation” agents) into a matrix polymer and orienting the polymer by stretching in at least one direction. During stretching, small cavities or voids are formed around the voiding agent. When voids are introduced into polymer films, the resulting voided film not only has a lower density than the non-voided film, but also becomes opaque and develops a paper-like surface. This surface also has the advantage of increased printability; that is, the surface is capable of accepting many inks with a substantially greater capacity over a non-voided film. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; U.S. Patent Application Publication No.'s 2001/0036545; 2003/0068453; 2003/0165671; 2003/0170427; Japan Patent Application No.'s 61-037827; 63-193822; 2004-181863; European Patent No. 0 581 970 B1, and European Patent Application No. 0 214 859 A2.

In certain embodiments, the as extruded films are oriented while they are stretched. The oriented films or shrinkable films of the present disclosure can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. It may be desirable to coextrude the polyesters useful in the present disclosure with another polymer, such as PET, to make the films useful in making the oriented films and/or shrink films of this disclosure. One advantage of doing the latter is that a tie layer may not be needed in some embodiments.

In one embodiment, the monoaxially and biaxially oriented films of the present disclosure can be made from films having a thickness of about 100 to 400 microns, for example, extruded, cast or calendered films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as-extruded film can be performed on a tenter frame according to these orientation conditions. The shrink films of the present disclosure can be made from the oriented films of this disclosure.

In certain embodiments, the shrink films of the present disclosure have gradual shrinkage with little to no wrinkling. In certain embodiments, the shrink films of the present disclosure have no more than 40% shrinkage in the transverse direction per 5° C. temperature increase increment.

In certain embodiments of the present disclosure, the shrink films of this disclosure have shrinkage in the machine direction of from 10% or less, or 5% or less, or 3% or less, or 2% or less, or no shrinkage when immersed in water at 65° C. for 10 seconds. In certain embodiments of the present disclosure, the shrink films of this disclosure have shrinkage in the machine direction of from −10% to 10%, −5% to 5%, or −5% to 3%, or −5% to 2%, or −4% to 4%, or −3% to 4% or −2% to 4%, or −2% to 2.5%, or −2% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In certain embodiments of the present disclosure, the shrink films of this disclosure have shrinkage in the main shrinkage direction of from 50% or greater, or 60% or greater, or 70% or greater, when immersed in water at 95° C. for 10 seconds.

In certain embodiments of the present disclosure, the shrink films of this disclosure have shrinkage in the main shrinkage direction in the amount of 50 to 90% and shrinkage in the machine direction of 10% or less, or from −10% to 10%, when immersed in water at 95° C. for 10 seconds.

In one embodiment, the polyesters useful in the present disclosure are made into films using any method known in the art to produce films from polyesters, for example, solution casting, extrusion, compression molding, or calendering. The as-extruded (or as-formed) film is then oriented in one or more directions (e.g., monoaxially and/or biaxially oriented film). This orientation of the films can be performed by any method known in the art using standard orientation conditions. For example, the monoaxially oriented films of the present disclosure can be made from films having a thickness of about 100 to 400 microns, such as, extruded, cast or calendered films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as extruded film can be performed on a tenter frame according to these orientation conditions.

In certain embodiments of the present disclosure, the shrink films of this disclosure have no more than 40% shrinkage in the transverse direction per 5° C. temperature increase increment.

In certain embodiments of the present disclosure, the shrink films of this disclosure can have an onset of shrinkage temperature of from about 55 to about 80° C., or about 55 to about 75° C., or 55 to about 70° C. Onset of shrinkage temperature is the temperature at which onset of shrinking occurs.

In certain embodiments of the present disclosure, the shrink films of this disclosure can have an onset of shrinkage temperature of between 55° C. and 70° C.

In certain embodiments of the present disclosure, the shrink films of this disclosure can have a break strain percentage greater than 200% at a stretching speed of 500 mm/minute in the direction orthogonal to the main shrinkage direction according to ASTM Method D882.

In certain embodiments of the present disclosure, the shrink films of this disclosure can have a break strain percentage of greater than 300% at a stretching speed of 500 mm/minute in the direction orthogonal to the main shrinkage direction according to ASTM Method D882.

In certain embodiments of the present disclosure, the shrink films of this disclosure can have a tensile stress at break (break stress) of from 20 to 400 MPa; or 40 to 260 MPa; or 42 to 260 MPa as measured according to ASTM Method D882.

In certain embodiments of the present disclosure, the shrink films of this disclosure can have a shrink force of from 4 to 18 MPa, or from 4 to 15 MPa, as measured by ISO Method 14616 depending on the stretching conditions and the end-use application desired. For example, certain labels made for plastic bottles can have an MPa of from 4 to 8 and certain labels made for glass bottles can have a shrink force of from 10 to 14 Mpa as measured by ISO Method 14616 using a Shrink Force Tester made by LabThink@80° C.

In one embodiment of the present disclosure, the polyester compositions can be formed by reacting the monomers by known methods for making polyesters in what is typically referred to as reactor grade compositions.

In one embodiment of the present disclosure, the polyester compositions of this disclosure can be formed by blending polyesters, such as polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester) to achieve the monomer ranges of these compositions.

In certain embodiments, the polyester compositions and the polymer blend compositions can also contain from 0.01 to 25% by weight of the overall composition common additives such as colorants, toner(s), dyes, mold release agents, flame retardants, plasticizers, glass bubbles, nucleating agents, stabilizers, including but not limited to, UV stabilizers, thermal stabilizers and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyester compositions disclosed herein which may or may not consist of or contain shrink films and are included within the scope of the present disclosure.

Generally, the shrink films according to the present disclosure may contain from 0.01 to 10 weight percent of the polyester plasticizer. In one embodiment, the shrink films can contain from 0.1 to 5 weight percent of the polyester plasticizer. Generally, the shrink films can contain from 90 to 99.99 weight percent of the copolyester. In certain embodiments, the shrink films can contain from 95 to 99.9 weight percent of the copolyester.

In one embodiment, when having a pre-oriented thickness of about 100 to 400 microns followed by orientation on a tenter frame at from a ratio of 6.5:1 to 3:1 at a temperature of from Tg to Tg+55° C. to a thickness of from about 20 to about 80 microns, the shrink films of the present disclosure can have one or more of the following properties:

(1) shrinkage in the main shrinkage direction or transverse direction in the amount of greater than 60% (or greater than 70%), and 10% or less (or from −5% to 4%) shrinkage in the machine direction when immersed in water at 95° C. for 10 seconds;

(2) an onset of shrinkage temperature of from about 55° C. to about 70° C.;

(3) a break strain percentage of greater than 200% at stretching speeds of 500 mm/minute, or 200 to 600%, or 200 to 500%, or 226 to 449%, or 250 to 455% in the transverse direction or in the machine direction or in both directions according to ASTM Method D882;

(4) no more than 40% shrinkage per each 5° C. temperature increase increment; and/or

(5) strain induced crystalline melting point greater than 200° C. Any combination of these properties or all of these properties can be present in the shrink films of this disclosure. The shrink films of the present disclosure can have a combination of two or more of the above described shrink film properties. The shrink films of the present disclosure can have a combination of three or more of the above described shrink film properties. The shrink films of the present disclosure can have a combination of four or more of the above described shrink film properties. In certain embodiments, properties (1)-(2) are present. In certain embodiments, properties (1)-(5) are present. In certain embodiments, properties (1)-(3) are present, etc.

The shrinkage percentages herein are based on initial as-formed films having a thickness of about 20 to 80 microns that have been oriented at a ratio of from 6.5:1 to 3:1 at a temperature of Tg to Tg+55° C. on a tenter frame, for example, at a ratio of 5:1 at a temperature from 70° C. to 85° C. In one embodiment, the shrinkage properties of the oriented films used to make the shrink films of this disclosure were not adjusted by annealing the films at a temperature higher than the temperature in which it was oriented.

The shape of the films useful in making the oriented films or shrink films of the present disclosure is not restricted in any way. For example, it may be a flat film or a film that has been formed into a tube. In order to produce the shrink films useful in the present disclosure, the polyester is first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction perpendicular to the MD of the film). Biaxially oriented films may be sequentially oriented, simultaneously oriented, or oriented by some combination of simultaneous and sequential stretching.

The films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films 5° C. to 80° C. above their glass transition temperature (Tg). In one embodiment, the films can be preliminarily heated from 10° C. to 30° C. above their Tg. In one embodiment, the stretch rate is from 5 to 20 inches (12.7 to 50.8 cm) per second. Next, the films can be oriented, for example, in either the machine direction, the transverse direction, or both directions from 2 to 6 times the original measurements. The films can be oriented as a single film layer or can be coextruded with another polyester such as PET (polyethylene terephthalate) as a multilayer film and then oriented.

In one embodiment, the present disclosure includes an article of manufacture or a shaped article comprising the shrink films of any of the shrink film embodiments of this disclosure. In another embodiment, the present disclosure includes an article of manufacture or a shaped article comprising the oriented films of any of the oriented film embodiments of this disclosure.

In certain embodiments, the present disclosure includes but is not limited to shrink films applied to containers, plastic bottles, glass bottles, packaging, batteries, hot fill containers, and/or industrial articles or other applications. In one embodiment, the present disclosure includes but is not limited to oriented films applied to containers, packaging, plastic bottles, glass bottles, photo substrates such as paper, batteries, hot fill containers, and/or industrial articles or other applications.

In certain embodiments of the present disclosure, the shrink films of this disclosure can be formed into a label or sleeve. The label or sleeve can then be applied to an article of manufacture, such as, the wall of a container, battery, or onto a sheet or film.

The oriented films or shrink films of the present disclosure can be applied to shaped articles, such as, sheets, films, tubes, bottles and are commonly used in various packaging applications. For example, films and sheets produced from polymers such as polyolefins, polystyrene, poly(vinyl chloride), polyesters, polylactic acid (PLA) and the like are used frequently for the manufacture of shrink labels for plastic beverage or food containers. For example, the shrink films of the present disclosure can be used in many packaging applications where the shrink film applied to the shaped article exhibits properties, such as, good printability, high opacity, higher shrink force, good texture, and good stiffness.

The combination of the improved shrink properties as well as the improved toughness should offer new commercial options, including but not limited to, shrink films applied to containers, plastic bottles, glass bottles, packaging, batteries, hot fill containers, and/or industrial articles or other applications.

In one aspect of the present disclosure, the disclosed polyester compositions are useful as thermoformed and/or thermoformable film(s) or sheet(s). The present disclosure is also directed to articles of manufacture which incorporate the thermoformed film(s) and/or sheet(s) of this disclosure. In one embodiment, the polyesters compositions of the present disclosure are useful as films and sheets which are easily formed into shaped or molded articles. In one embodiment, the film(s) and/or sheet(s) of the present disclosure may be processed into molded articles or parts by thermoforming. The polyester compositions of the present disclosure may be used in a variety of molding and extrusion applications.

In addition, in one embodiment, the polyester compositions and the polyester blend compositions useful in the thermoformed sheet(s) of this disclosure may also contain from 0.1 to 25% by weight of the overall composition common additives such as colorants, mold release agents, flame retardants, plasticizers, nucleating agents, stabilizers, including but not limited to, UV stabilizers, thermal stabilizers, fillers, and impact modifiers.

In one embodiment, reinforcing materials may be included in the thermoformed film(s) or sheet(s) comprising the polyester compositions of this disclosure. For examples, suitable the reinforcing materials may include carbon filaments, silicates, mica, clay, talc, titanium dioxide, Wollastonite, glass flakes, glass beads and fibers, and polymeric fibers and combinations thereof.

In one embodiment, the thermoformed films or sheets are multilayered films or sheets. In one embodiment at least one layer of the multilayer film or sheet is a foam or foamed polymer or polyester layer.

One aspect of the present disclosure is a method of making molded or shaped parts and articles using thermoforming. Any thermoforming techniques or processes known to those skilled in the art may be used to produce the molded or shaped articles of this disclosure.

In one embodiment, the thermoforming processes can be done in several ways, for example as taught in “Technology of Thermoforming”; Throne, James; Hanser Publishers; 1996; pp. 16-29, which is incorporated herein by reference. In some embodiments, it is a positive thermoforming process where gas or air pressure is applied to the softened sheet, the sheet is then stretched and drawn out like a bubble and a male mold is brought into the bubble from the inside. Then vacuum is applied to further draw and conform the part to the male mold surface. In this thermoforming process biaxial stretching/orientation is done primarily in one step when there is a gas or air pressure applied to the softened sheet. The molding step is then completed with the vacuum and male mold to freeze the orientation into the sheet for a good balance of physical and appearance properties. In other embodiments, it is a negative thermoforming process where a vacuum or a physical plug is applied to the heat softened sheet and stretches and draws the sheet to nearly the final part size, and then, positive air pressure from the inside or further external vacuum from the outside draws and conforms the sheet against an outer, female mold, the orientation is frozen into the polymer and the sheet is formed into the article.

In some embodiments, the produced bubble is sometimes further formed by making use of a plug assist, and this is followed by draping and shaping the sheet over the rising positive mold and then the corners and shelves guides, etc. are pulled into the mold by applying a vacuum. In some embodiments, after removal from the mold, the molded parts or articles can be trimmed, holes punched, and corners cut out as needed.

In other embodiments, thermoforming is a process where a film or sheet of the polyester compositions of the present disclosure are heated to a temperature sufficient to allow the deformation thereof, and the heated film or sheet is then made to conform to the contours of a mold by such means as vacuum assist, air pressure assist and matched mold assist. In another embodiment, the heated film or sheet is placed in a mold and forced to conform to the contours of the mold by, for example, application of air pressure, application of a vacuum, plug assist or application of a matching mold. In some embodiments, thermoforming produces thin wall articles.

In one embodiment, the thermoforming process molds the films or sheets into the desired shapes through the pressing of positive molds into the heated films or sheets. In this embodiment, thermoforming involves having a positive mold of an article supported between a vacuum-equipped surface or table. In this embodiment, heat from an external heat source such as a hot air blower, heat lamp or other radiant heat source is directed at the film or sheet. In this embodiment, the film or sheet is heated to the point of softening. In this embodiment, a vacuum is then applied to and below the table and around the mold, and the heat softened film or sheet is drawn toward the table, thus placing the softened film or sheet in contact with the mold surface. In this embodiment, the vacuum draws the softened film or sheet into tight contact with, and conformance to, the contours of the mold surface. As such, the film or sheet then assumes the shape of the mold. In this embodiment, after the film or sheet cools, it hardens, and the resulting article or part may be removed from the mold.

In one embodiment, the thermoforming process comprises: forming a film or sheet from the polyester compositions of the present disclosure; heating the film or sheet until it softens and positioning it over a mold; drawing the preheated film or sheet onto the heated mold surface; cooling the film or sheet; and then removing the molded article or part from the mold cavity, or optionally, heatsetting the formed film or sheet by maintaining the film or sheet in contact against the heated mold for a sufficient time period to partially crystallize the film or sheet.

In one embodiment, the thermoforming process comprising: forming a film or sheet from the polyester compositions of the present disclosure; heating a film or sheet to a temperature at or above the Tg of the polyester; applying gas, vacuum and/or physical pressure to the heat softened film or sheet and stretching the film or sheet to nearly the final part size; conforming the sheet by vacuum or pressure to a mold shape; cooling the film or sheet to a temperature below the Tg of the polyester; and then removing the thermoformed article or part from the mold.

The film and sheet used in the thermoforming process can be made by any conventional method known to those skilled in the art. In one embodiment, the sheet or film is formed by extrusion. In one embodiment, the sheet or film is formed by calendering. In one embodiment, during the thermoforming process the film or sheet is heated to a temperature at or above the Tg of the polyester. In one embodiment, this temperature is about 10 to about 60° C. above the Tg of the polyester. In one embodiment, the heating of the film or sheet prior to positioning over the thermoforming mold is necessary in order to achieve a shorter molding time. In one embodiment, the sheet must be heated above its Tg and below the point at which it sags excessively during positioning over the mold cavity. In one embodiment, before the molded film or sheet is removed from the mold it is allowed to cool to a temperature below the Tg of the polyester. In one embodiment, the thermoforming methods may include vacuum assist, air assist, mechanical plug assist or matched mold. In some embodiments, the mold is heated to a temperature at or above the Tg of the film or sheet. Selection of optimum mold temperature is dependent upon type of thermoforming equipment, configuration and wall thickness of article being molded and other factors.

In some embodiments, the heated film or sheet is stretched by creating and pulling a vacuum.

In one embodiment, heatsetting is the process of thermally inducing partial crystallization of a polyester film or sheet without appreciable orientation being present. In one embodiment, heatsetting is achieved by maintaining contact of the film or sheet with the heated mold surface for a sufficient time to achieve a level of crystallinity which gives adequate physical properties to the finished part. In one embodiment, the levels of crystallinity should be about 10 to about 30 percent.

In one embodiment, the heatset part can be removed from the mold cavity by known means for removal. For example, in one embodiment, blowback is used and it involves breaking the vacuum established between the mold and the formed film or sheet by the introduction of compressed air. In some embodiments, the molded article or part is subsequently trimmed and the scrap ground and recycled.

In some embodiments, the addition of nucleating agents provide faster crystallization during thermoforming and thus provide for faster molding. In one embodiment, nucleating agents such as fine particle size inorganic or organic materials may be used. For example, in one embodiment, suitable nucleating agents include talc, titanium dioxide, calcium carbonate, and immiscible or cross-linked polymers. In one embodiment, the nucleating agents are used in amounts varying from about 0.01% to about 20%, based on the weight of the article. In one embodiment, other conventional additives such as pigments, dyes, plasticizers, anti-cracking agent and stabilizers may be used as needed for thermoforming. In some embodiments, the anti-cracking agent improves impact strength, and the nucleating agent provides faster crystallization. In some embodiments, crystallization is necessary to achieve high temperature stability.

In one embodiment, a foamed polyester film or sheet is made by foaming a polyester composition of the present disclosure with chemical and/or physical blow agents, extruding the foamed polyester into sheet or film, and thermoforming the foamed polyester film or sheet. Additives for providing enhanced properties to the foamed polyester film may be added to the polyester prior to foaming. Some examples of additives include slip agents, antiblocking agents, plasticizers, optical brightener and ultra violet inhibitor. In one embodiment, the foamed polyester films can be extrusion or lamination coated on one side or on both sides using conventional techniques in order to enhance its properties. In one embodiment, the coating materials may be the printed surface, rather than the foam film itself, that provides for product labelling.

The compositions of this disclosure are useful as molded or shaped plastic parts or as solid plastic objects. The compositions of this disclosure are useful as thermoformed parts or articles. The compositions are suitable for use in any applications where clear, hard plastics are required. Examples of such parts include disposable knives, forks, spoons, plates, cups, straws as well as eyeglass frames, toothbrush handles, toys, automotive trim, tool handles, camera parts, parts of electronic devices, razor parts, ink pen barrels, disposable syringes, bottles, and the like. In one embodiment, the compositions of the present disclosure are useful as plastics, films, fibers, and sheets. In one embodiment the compositions are useful as plastics to make bottles, bottle caps, eyeglass frames, cutlery, disposable cutlery, cutlery handles, shelving, shelving dividers, electronics housing, electronic equipment cases, computer monitors, printers, keyboards, pipes, automotive parts, automotive interior parts, automotive trim, signs, thermoformed letters, siding, toys, thermally conductive plastics, ophthalmic lenses, tools, tool handles, and utensils. In another embodiment, the compositions of the present disclosure are suitable for use as films, sheeting, fibers, molded articles, shaped articles, molded parts, shaped parts, medical devices, dental trays, dental appliances, containers, food containers, shipping containers, packaging, bottles, bottle caps, eyeglass frames, cutlery, disposable cutlery, cutlery handles, shelving, shelving dividers, furniture components, electronics housing, electronic equipment cases, computer monitors, printers, keyboards, pipes, toothbrush handles, automotive parts, automotive interior parts, automotive trim, signs, outdoor signs, skylights, multiwall film, multilayer film, insulated parts, insulated articles, insulated containers, thermoformed letters, siding, toys, toy parts, trays, food trays, dental trays, thermally conductive plastics, ophthalmic lenses and frames, tools, tool handles, and utensils, healthcare supplies, commercial foodservice products, boxes, film for graphic arts applications, plastic film for plastic glass laminates, point of purchase displays, skylights, smoke vents, laminated cards, fenestration, glazing, partitions, ceiling tiles, lighting, machine guards, graphic arts, lenticular, extrusion laminated sheets or films, decorative laminates, office furniture, face shields, medical packaging, sign holders on point of display shelving, and shelf price holds.

The present thermoformed or thermoformable compositions are useful in forming films, molded articles, molded parts, shaped articles, shaped parts and sheeting. The methods of making the thermoformed or thermoformable compositions into films, molded articles, molded parts, shaped articles, shaped parts and sheeting can be according to any methods known in the art. Examples of molded articles include without limitation: medical devices, medical packaging, healthcare supplies, commercial foodservice products such as trays, containers, food pans, tumblers, storage boxes, bottles, food processors, blender and mixer bowls, utensils, water bottles, crisper trays, washing machine parts, refrigerator parts, vacuum cleaner parts, ophthalmic lenses and frames, and toys.

This disclosure further relates to articles of manufacture comprising the film(s) and/or sheet(s) containing polyester compositions described herein. In embodiments, the films and/or sheets of the present disclosure can be of any thickness as required for the intended application.

This disclosure further relates to the film(s) and/or sheet(s) described herein. The methods of forming the polyester compositions into film(s) and/or sheet(s) includes any methods known in the art. Examples of film(s) and/or sheet(s) of the disclosure including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, wet block processing, dry block processing and solution casting.

This disclosure further relates to the molded or shaped articles described herein. The methods of forming the polyester compositions into molded or shaped articles includes any known methods in the art. Examples of molded or shaped articles of this disclosure including but not limited to thermoformed or thermoformable articles, injection molded articles, extrusion molded articles, injection blow molded articles, injection stretch blow molded articles and extrusion blow molded articles. Methods of making molded articles include but are not limited to thermoforming, injection molding, extrusion, injection blow molding, injection stretch blow molding, and extrusion blow molding. The processes of this disclosure can include any thermoforming processes known in the art. The processes of this disclosure can include any blow molding processes known in the art including, but not limited to, extrusion blow molding, extrusion stretch blow molding, injection blow molding, and injection stretch blow molding.

This disclosure includes any injection blow molding manufacturing process known in the art. Although not limited thereto, a typical description of injection blow molding (IBM) manufacturing process involves: 1) melting the composition in a reciprocating screw extruder; 2) injecting the molten composition into an injection mold to form a partially cooled tube closed at one end (i.e. a preform); 3) moving the preform into a blow mold having the desired finished shape around the preform and closing the blow mold around the preform; 4) blowing air into the preform, causing the preform to stretch and expand to fill the mold; 5) cooling the molded article; 6) ejecting the article from the mold.

This disclosure includes any injection stretch blow molding manufacturing process known in the art. Although not limited thereto, a typical description of injection stretch blow molding (ISBM) manufacturing process involves: 1) melting the composition in a reciprocating screw extruder; 2) injecting the molten composition into an injection mold to form a partially cooled tube closed at one end (i.e. a preform); 3) moving the preform into a blow mold having the desired finished shape around the preform and closing the blow mold around the preform; 4) stretching the preform using an interior stretch rod, and blowing air into the preform causing the preform to stretch and expand to fill the mold; 5) cooling the molded article; 6) ejecting the article from the mold.

This disclosure includes any extrusion blow molding manufacturing process known in the art. Although not limited thereto, a typical description of extrusion blow molding manufacturing process involves: 1) melting the composition in an extruder; 2) extruding the molten composition through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article of the mold; and 7) removing excess plastic (commonly referred to as flash) from the article.

In another aspect of the present disclosure, it has been discovered that it is possible to produce the polyester resins of the present disclosure from recycled copolyesters and/or recycled polyesters.

One embodiment of the present disclosure is a process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and optionally additional added glycols in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA) or esters thereof; and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG), or diethylene glycol (DEG), and optionally adding additional recycled polyesters comprising one or more of recycled PET, recycled PETG, recycled PCT, recycled PCTA or recycled PCTG; and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and optionally adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and optionally adding additional recycled polyesters comprising one or more of recycled PET, recycled PETG, recycled PCT, recycled PCTA or recycled PCTG; and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and optionally adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone and optionally adding additional recycled polyesters comprising one or more of recycled PET, recycled PETG, recycled PCT, recycled PCTA or recycled PCTG to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA); and ethylene glycol (EG) into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and adding recycled polyesters comprising one or more of recycled PET, recycled PETG, recycled PCT, recycled PCTA or recycled PCTG; and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer.
(d) reacting the TPA and EG with the at least one additional glycol in the first reaction zone at a melt temperature of at least 175° C. to form a first esterification product comprising oligomers and unreacted TPA, EG, and the additional glycol(s);
(e) passing the first esterification product to a second reaction zone;
(f) reacting further the first esterification product and optionally adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone and optionally adding additional recycled polyesters comprising one or more of recycled PET, recycled PETG, recycled PCT, recycled PCTA, recycled PCTG, recycled PCTM or recycled PETM to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG) and adding additional recycled polyesters comprising one or more of recycled PET, recycled PETG, recycled PCT, recycled PCTA or recycled PCTG; and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone and optionally adding additional recycled polyesters comprising one or more of recycled PET, recycled PETG, recycled PCT, recycled PCTA or recycled PCTG to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and optionally adding additional recycled PET, recycled PETG, recycled PCT, recycled PCTA or recycled PCTG; and optionally terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and optionally adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone and adding additional recycled polyesters recycled polyesters comprising one or more of recycled PET, recycled PETG, recycled PCT, recycled PCTA or recycled PCTG to form a polymerization product comprising polyesters, optionally in the presence of a polycondensation catalyst and/or a stabilizer.

One embodiment of the present disclosure is a process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and adding additional recycled PET, recycled PETG, recycled PCT, recycled PCTA or recycled PCTG; and optionally terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG with the at least one additional glycol in the first reaction zone at a melt temperature of at least 200° C. to form a first esterification product comprising oligomers and unreacted TPA, EG, and the additional glycol(s);
(e) passing the first esterification product to a second reaction zone;
(f) reacting further the first esterification product and adding additional glycols comprising one or more of CHDM, NPG or DEG and/or additional recycled polyesters comprising one or more of recycled PET, recycled PETG, recycled PCT, recycled PCTA or recycled PCTG in the second reaction zone at a melt temperature of at least 200° C. to form a second esterification product comprising polyester oligomers, optionally in the presence of an esterification catalyst and/or a stabilizer;
(g) passing the second esterification product to a third reaction zone; and
(h) polycondensing the second esterification product in the third reaction zone and adding additional recycled polyesters recycled polyesters comprising one or more of recycled PET, recycled PETG, recycled PCT, recycled PCTA or recycled PCTG to form a polymerization product comprising polyesters, optionally in the presence of a polycondensation catalyst and/or a stabilizer.

In one embodiment, the recycled polyester and/or copolyester can be recovered as manufacturing scrap or industrial waste or post-consumer recycled (PCR) waste. Typically, PCR or recycled waste are articles made from polyesters or copolyesters that have been used and discarded. Today, PET is recycled by mechanical methods and incorporated into new PET bottles and other PET articles as blends with virgin material.

The copolyesters with recycled content and the copolyesters made from recycled content comprise dicarboxylic acid monomer residues, diol or glycol monomer residues, and repeating units. Thus, the term “monomer residue”, as used herein, means a residue of a dicarboxylic acid, a diol or glycol, or a hydroxycarboxylic acid. A “repeating unit”, as used herein, means an organic structure having 2 monomer residues bonded through a carbonyloxy group. The copolyesters of the present disclosure contain substantially equal molar proportions of acid residues (100 mole %) and glycol residues (100 mole %) which react in substantially equal proportions such that the total moles of repeating units is equal to 100 mole %. The mole percentages provided in the present disclosure, therefore, may be based on the total moles of acid residues, the total moles of glycol residues, or the total moles of repeating units. For example, a copolyester containing 30 mole % of a monomer, which may be a dicarboxylic acid, a glycol, or hydroxycarboxylic acid, based on the total repeating units, means that the copolyester contains 30 mole % monomer out of a total of 100 mole % repeating units. Thus, there are 30 moles of monomer residues among every 100 moles of repeating units. Similarly, a copolyester containing 30 mole % of a dicarboxylic acid monomer, based on the total acid residues, means the polyester contains 30 mole % dicarboxylic acid monomer out of a total of 100 mole % acid residues. Thus, in this latter case, there are 30 moles of dicarboxylic acid monomer residues among every 100 moles of acid residues.

The term “polyester”, as used herein, encompasses both “homopolymers” and “homopolyesters” and “copolyesters” and means a synthetic polymer prepared by the polycondensation of at least one diacid component, comprising one or more difunctional carboxylic acids, with a least one glycol component, comprising one or more, difunctional hydroxyl compounds. The term “copolyester,” as used herein, is intended to mean a polyester formed from the polycondensation of at least 3 different monomers, e.g., a dicarboxylic acid with 2 or more glycols or, in another example, a diol with 2 or more different dicarboxylic acids. Typically, the difunctional carboxylic acid is a dicarboxylic acid and the difunctional hydroxyl compound is a dihydric alcohol such as, for example glycols and diols. Alternatively, the difunctional carboxylic acid may be a hydroxy carboxylic acid such as, for example, p-hydroxybenzoic acid, and the difunctional hydroxyl compound may be an aromatic nucleus bearing 2 hydroxy substituents such as, for example, hydroquinone. The term “residue”, as used herein, means any organic structure incorporated into the polymer through a polycondensation reaction involving the corresponding monomer. The dicarboxylic acid residue may be derived from a dicarboxylic acid monomer or its associated acid halides, esters, salts, anhydrides, or mixtures thereof. For example, in one embodiment, for the copolyesters of the present disclosure, the diacid component is supplied as terephthalic acid or isophthalic acid.

The recycled polyesters and/or copolyesters can be repolymerized into copolyesters using any polycondensation reaction conditions known in the art. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein the reactants are introduced, and the products are withdrawn simultaneously in an uninterrupted manner. The process is operated advantageously as a continuous process for economic reasons and to produce superior coloration of the polymer as the copolyester may deteriorate in appearance if allowed to reside in a reactor at an elevated temperature for too long a duration.

The copolyesters of the present disclosure are prepared by procedures known to persons skilled in the art. The reaction of the diol component and the dicarboxylic acid component may be carried out using conventional copolyester polymerization conditions. For example, when preparing the copolyester by means of an ester interchange reaction, e.g., from the ester form of the dicarboxylic acid components, the reaction process may comprise two steps. In the first step, the diol component and the dicarboxylic acid component, such as, for example, terephthalic acid, are reacted at elevated temperatures, about 150° C. to about 250° C. for about 0.5 to about 8 hours at pressures ranging from about 0.0 kPa gauge to about 414 kPa gauge (60 pounds per square inch, “psig”). The temperature for the ester interchange reaction ranges from about 180° C. to about 230° C. for about 1 to about 4 hours while the pressure ranges from about 103 kPa gauge (15 psig) to about 276 kPa gauge (40 psig). Thereafter, the reaction product is heated under higher temperatures and under reduced pressure to form the copolyester with the elimination of diol, which is readily volatilized under these conditions and removed from the system.

This second step, or polycondensation step, is continued under higher vacuum and a temperature which generally ranges from about 230° C. to about 350° C., or from about 250° C. to about 310° C., or from about 260° C. to about 290° C. for about 0.1 to about 6 hours, or for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture, and removal of water, excess glycol, or alcohols to facilitate reaction and polymerization. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ about 1.05 to about 2.5 moles of diol component to one mole dicarboxylic acid component followed by removal of the excess glycol in a subsequent step. Persons of skill in the art will understand, however, that the ratio of diol component to dicarboxylic acid component is generally determined by the design of the reactor in which the reaction process occurs.

In the preparation of a copolyester by direct esterification, e.g., from the acid form of the dicarboxylic acid component, copolyesters are produced by reacting the dicarboxylic acid or a mixture of dicarboxylic acids with the glycol component or a mixture of glycol components. The reaction is conducted at a pressure of from about 7 kPa gauge (1 psig) to about 1379 kPa gauge (200 psig), or from less than 689 kPa (100 psig) to produce a low molecular weight, linear or branched copolyester product having an average degree of polymerization of from about 1.4 to about 10. The temperatures employed during the direct esterification reaction are from about 180° C. to about 280° C., or from about 220° C. to about 270° C. This low molecular weight polymer may then be polymerized by a polycondensation reaction.

In some embodiments, suitable glycols include but are not limited to, ethylene glycol, diethylene glycol, triethylene glycol, propylene glycol, polyethylene glycol, 1,2-propanediol, 1,3-propanediol, neopentyl glycol, 1,4-butanediol, 1,5-pentanediol, 1,6-hexanediol, p-xylene glycol, 1,4-cyclohexanedimethanol, 2,2,4,4-tetramethylcyclobutane1,3-diol, polytetramethylene glycol, isosorbide or mixtures thereof.

In some embodiments, copolyesters including the following diacids are suitable for use in the repolymerization process or in the polymerization process to make new copolyesters with recycle content: terephthalic acid, isophthalic acid, trimellitic anhydride (or acid), naphthalene dicarboxylic acid, and 1,4-cyclohexanedicarboxylic acid.

In some embodiments, copolyesters including the following glycols are suitable for use in the repolymerization process or in the polymerization process to make new copolyester with recycle content: ethylene glycol, diethylene glycol, triethylene glycol, propylene glycol, polyethylene glycol, 1,2-propanediol, 1,3-propanediol, neopentyl glycol, 1,4-butanediol, 1,5-pentanediol, 1,6-hexanediol, p-xylene glycol, 1,4-cyclohexanedimethanol, 2,2,4,4-tetramethylcyclobutane1,3-diol, polytetramethylene glycol, isosorbide or mixtures thereof.

In one embodiment, recycled waste materials comprising terephthalate polyesters and/or copolyesters can be used in the repolymerization process. In one embodiment, any conventionally prepared terephthalate polyesters or copolyesters can be used in the repolymerization process. In one embodiment, suitable terephthalate polyesters and/or copolyesters include poly(ethylene terephthalate) (PET), (polyethylene terephthalate, glycol-modified (PETG), poly(cyclohexylene dimethylene terephtalate), glycol-modified (PCTG), poly(cyclohexylene dimethylene terephtalate), acid (PCTA), poly(butylene terephthalate) (PBT), poly(propylene terephthalate) (PPT), polytrimethylene terephthalate (PTT), polycyclohexane dimethanol terephthalate (PCT), Polyethylene naphthalate (PEN), poly(ethylene terephthalate), TMCD modified (PETM), poly(cyclohexylene dimethylene terephtalate), TMCD modified (PCTM), and mixtures thereof. In one embodiment, the terephthalate polyester is poly(ethylene terephthalate) (PET). In one embodiment, the copolyester is PETG. In one embodiment, the copolyester is PCT. In one embodiment, the copolyester is PCTG. In one embodiment, the copolyester is PCTA. In one embodiment, the copolyester is PCTM. In one embodiment, the copolyester is PETM.

In one embodiment, mixtures of terephthalate polyesters and copolyesters are repolymerized together in combination. In one embodiment, PET and PETG are repolymerized together in combination. In one embodiment, PET and PETM are repolymerized together in combination. In one embodiment, PET and PCT are repolymerized together in combination. In one embodiment, PET and PCTA are repolymerized together in combination. In one embodiment, PET and PCTG are repolymerized together in combination. In one embodiment, PET and PCTM are repolymerized together in combination. In one embodiment, PET and PETG and PETM are repolymerized together in combination. In one embodiment, PET and PETG and PCTM are repolymerized together in combination. In one embodiment, PET, PETG, PCTM and PETM are repolymerized together in combination.

In one embodiment, the copolyesters suitable for use in the present disclosure are prepared from monomers such as, for example, dimethyl terephthalate (DMT), terephthalic acid (TPA), isophthalic acid (IPA), 1,4-cyclohexanedicarboxylic acid (CHDA), ethylene glycol (EG), diethylene glycol (DEG), neopentyl glycol (NPG),1,4-cyclohexanedimethanol (CHDM), and 2,2,4,4-tetramethyl-1,3-cyclobutanediol (TMCD).

One embodiment, of the present disclosure, pertains to a process for the preparation of copolyesters having a high level of recycled content obtained by repolymerizing scrap or post-consumer polyesters including terephthalate-containing polyesters (e.g., PET) and/or copolyesters (e.g., PETG) with water or an alcohol or glycol, and using the recycled monomers to prepare copolyesters containing a high mole percentage of recycled monomer residues.

In one aspect of the present disclosure, high molecular weight copolyesters that contain glycol and diacid components, wherein the glycol components comprise ethylene glycol, diethylene glycol, triethylene glycol, propylene glycol, polyethylene glycol, 1,2-propanediol, 1,3-propanediol, neopentyl glycol, 1,4-butanediol, 1,5-pentanediol, dimethyl 1,4-cyclohexanedicarboxylate, trans-dimethyl 1,4-cyclohexanedicarboxylate, 1,6-hexanediol, p-xylene glycol, 1,4-cyclohexanedimethanol, 2,2,4,4-tetramethylcyclobutane-1,3-diol, polytetramethylene glycol, adipic acid, isosorbide and mixtures thereof and the diacid components comprise dimethyl terephthalate, terephthalic acid, isophthalic acid (IPA), trimellitic anhydride (or trimellitic acid), salts of 5-(sulfo)isophthalic acid (SIPA), naphthalene dicarboxylic acid, 1,4-cyclohexanedicarboxylic acid, and mixtures thereof; when a depolymerization aid or solvent such as water, an alcohol or excess glycol is introduced under conditions where the reversible ester exchange reaction can occur, then depolymerization by hydrolysis, alcoholysis or glycolysis will occur, reducing the chain length (molecular weight) of the polymer. With a sufficient quantity of the solvent, the reaction will proceed to a point where the mixture will consist primarily of monomers, glycols and the diesters of the acid component. In one aspect the glycols of the mixture comprise ethylene glycol, diethylene glycol, triethylene glycol, propylene glycol, polyethylene glycol, 1,2-propanediol, 1,3-propanediol, neopentyl glycol, 1,4-butanediol, 1,5-pentanediol, dimethyl 1,4-cyclohexanedicarboxylate, trans-dimethyl 1,4-cyclohexanedicarboxylate, 1,6-hexanediol, p-xylene glycol, 1,4-cyclohexanedimethanol, 2,2,4,4-tetramethylcyclobutane1,3-diol, polytetramethylene glycol, adipic acid, isosorbide and mixtures thereof. In one embodiment, the glycols of the mixture comprise ethylene glycol, 1,2-propanediol, 1,3-propanediol, neopentyl glycol, 1,4-butanediol, 1,5-pentanediol, 1,4-cyclohexanedimethanol, 2,2,4,4-tetramethylcyclobutane1,3-diol and mixtures thereof. In one embodiment, the glycols of the mixture comprise ethylene glycol, neopentyl glycol, 1,4-cyclohexanedimethanol, 2,2,4,4-tetramethylcyclobutane1,3-diol and mixtures thereof. These recycled monomers can then be used to prepare copolyesters containing a high mole percentage of recycled monomer residues.

This invention relates to a process for utilizing recycled polyethylene terephthalate (PET) and recycled glycol-modified polyethylene terephthalate copolyesters (PETG), especially post-consumer waste materials in the production of linear, high molecular weight copolyesters. There is a growing demand for using higher amounts of recycled material in plastic articles. This demand for recycle content has created a need to develop new methods and processes for capturing and converting existing plastic waste streams into new plastic articles. The recycling of PETG waste materials is of particular interest. In recent years, legislation has attempted to segregate recycled glycol-modified PET (PETG) waste product from recycled polyethylene terephthalate (PET) waste products that carry the resin identification code (RIC) 1 because of the issues experienced during the processing of these combined waste streams. Additionally, there is a large volume of PETG that is not recycled today that could be reclaimed and converted into new plastic articles. In particular, shrinkable films made with PETG contain inks and other contaminants that must be removed from recycling streams in order to produce high quality, clear recycled PET (rPET). Additionally, medical packaging is made from a large proportion of PETG and this material does not currently have a recycling stream. The present invention provides a process for utilizing recycled PETG and recycled PETG in combination with PET as a reactive intermediate in the production of copolyesters useful in the manufacture of such extruded and injection molded products as shrinkable films, fibers, durable goods, and other shaped articles and objects.

There exists today a very well-defined and large scale, mechanical recycling process whereby polyethylene terephthalate (PET) articles are reclaimed and converted into semi-crystalline, recycled PET (rPET) and further incorporated into new plastic articles. Glycol-modification of PET with other glycols like 1,4-cyclohexane diol, diethylene glycol, butanediol, or neopentyl glycol is a very common method to improve clarity, improve toughness, and reduce the crystallinity of PET. These glycol-modified materials are typically referred to as glycol-modified PET or PETG. Even though the chemical compositions of these materials are very similar to PET, the modification with glycols other than ethylene glycol creates materials that are difficult to recycle in the PET recycling process. New methods must be created to recover and recycle these PETG materials.

The process described in this disclosure uses recycled PETG as a raw material feed to make a variety of new copolyester resins. In this process, recycled PETG (rPETG) is introduced with ethylene glycol and terephthalic acid as a paste to feed the transesterification reactor at the beginning of the manufacturing process to produce new copolyesters. During the process, added glycols break down rPETG to its original acid and glycol residue starting materials, new glycols and acids are added, and the mixture is then esterified and polymerized to produce new copolyesters. This process has the advantage of using recycled PETG as a feedstock without the need to further purify the acids and glycols that are created. Additionally, this process is advantageous because it provides a method for using rPETG that currently does not have a mechanical recycling stream and thus would be placed in a landfill.

In addition, the rPETG (or rPCTG, or rPCTM, or rPETM, or rPCTA, or rPCTG, or rPCT) contains 2 or more higher value monomers that are not present in rPET such as CHDM, TMCD, DEG, and NPG. The PETG product that is produced from this process performs the same as virgin PETG and can be used in the exact same applications without sacrificing any performance by addition of the recycled material. Traditionally, rPETG is blended with virgin material to form a physical blend. These blends often lose performance either with respect to mechanical properties or in color and appearance and often cannot be used in the same applications as the virgin material.

It has become commercially desirable to use previously used, particularly post-consumer PET in the synthesis of new PET for making water and carbonated beverage bottles. Several chemical treatment techniques are known for facilitating the regeneration and recycling of previously used polyester material. Such techniques are employed to depolymerize the recycled polyester material, whereby the polyester material is reduced to monomeric and/or oligomeric components. The monomeric and/or oligomeric components may then be repolymerized to produce recycled polyester material.

One known depolymerization technique is to subject the recycle PET to methanolysis. In accordance with the methanolysis approach, the rPET is reacted with methanol to produce dimethyl terephthalate (DMT) and ethylene glycol (EG). The DMT and EG may be readily purified and thereafter used to produce PET containing recycled polyester material. However, most conventional commercial PET production facilities throughout the world are designed to use either terephthalic acid (TPA) and on a smaller scale some facilities use DMT, but most facilities are not designed to use both, TPA and DMT as the monomeric raw material. Thus, additional processing is generally required to convert the DMT into the TPA needed as a raw material for many such facilities, and in either case, further purification of the glycols and DMT/TPA is required.

Another known depolymerization technique is hydrolysis, whereby recycled PET is reacted with water to depolymerize the rPET into TPA and EG. However, it is known that certain types of contaminants generally present in recycled PET are very difficult and expensive to remove from TPA. Moreover, for those facilities designed to use DMT as a raw material, the TPA must be converted into DMT, and purification of the glycols and DMT/TPA is further required.

Glycolysis may also be used for depolymerizing recycled PET. Glycolysis occurs when the rPET is reacted with EG, thus producing bis-(2-hydroxyethyl) terephthalate (BHET) and/or its oligomers. Glycolysis has some significant advantages over either methanolysis or hydrolysis, primarily because BHET may be used as a raw material for either a DMT-based or a TPA-based PET production process without major modification of the production facility or further purification. Another significant advantage provided by the glycolysis technique is that the removal of glycol from the depolymerization solvent is not necessary.

Previously known glycolysis processes include the independent, complete glycolysis of post-consumer rPET and the subsequent addition of some portion of the glycolysis product to a polycondensation process. Such a glycolysis process is described in U.S. Pat. No. 5,223,544. Such processes require high pressures and a large excess of ethylene glycol. These requirements reduce the reactor efficiency by decreasing the potential production capacity of the reactor.

Typically, it has been found that high temperatures and large excesses of EG are required to solubilize the polyester molecule in these glycolysis processes so that it can then be broken down into its constituent parts such as BHET and oligomers thereof. The high temperatures and excessive EG results in the production of large quantities of diethylene glycol as a by-product. The diethylene glycol thus produced cannot be readily removed from the BHET and so, if the BHET is then used to produce regenerated PET, the resultant PET product has a diethylene glycol content that is excessive causing the polymer to be unacceptable for many commercial uses.

Other known processes involving glycolysis require the retention in the reactor of a heel of BHET oligomer having a degree of polymerization greater than 10 at the end of a reaction run in order to solubilize the post-consumer rPET because the latter is insoluble in most solvents. These procedures are described in U.S. Pat. No. 4,609,680. Thus, there clearly remains a need in the art for a glycolysis process that can efficiently handle previously used, post-consumer rPET in the manufacture of new packaging grade PET.

The present disclosure provides a solution to the problems discussed above. In particular, the process of the present disclosure provides an efficient and economical procedure for utilizing recycled polyesters and/or recycled copolyesters including recycled PET, recycled PETG, recycled PETM, and recycled PCTM or mixtures of these materials to produce packaging grade polyester products.

In one embodiment, the viscosity of the material in the paste zone and the viscosity of the material leaving the paste zone is much reduced with rPETG (and rPCTM or blends with rPET) than with rPET alone. In one embodiment, TPA dissolves faster in rPET than in EG alone. In one embodiment the TPA may dissolve even faster in rPETG, rPETM or rPCTM.

In one embodiment TPA is completely replaced with recycled polyester or copolyester.

In one embodiment, the composition control of the final polyester product is made by combination of the recycled feed and the components added to the first reaction zone.

In one embodiment of the present disclosure, the copolyesters are produced in two main stages. The first stage reacts starting materials to form monomers and/or oligomers. If the starting materials entering the first stage include acid end groups, such as TPA or isophthalic acid, the first stage is referred to as esterification. The esterification stage can be a single step or can be divided into multiple steps. The second stage further reacts the monomers and/or oligomers to form the final copolyester product. The second stage is generally referred to as the polycondensation stage. The polycondensation stage can be a single step or can be divided into a prepolycondensation (or prepolymerization) step and a final (or finishing) polycondensation step.

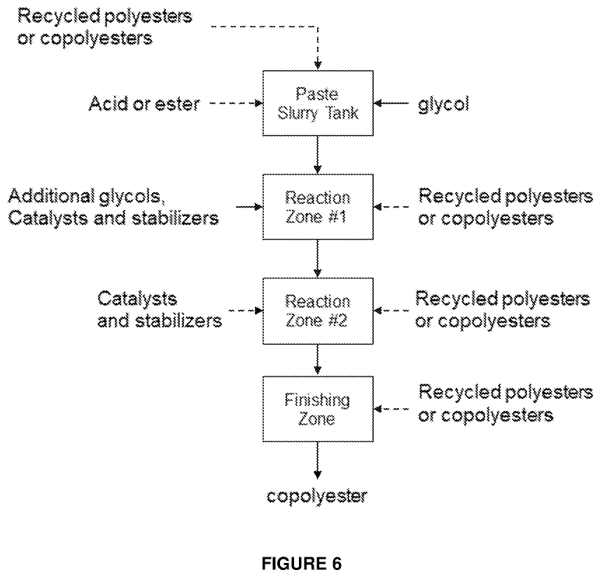

FIG. 6 shows a process flow diagram for making polyester or copolyesters such as PETG in accordance with various embodiments of this disclosure. While the flow diagram (FIG. 6) shows the reaction zones as separate vessels, which are typically continuous stirred tank reactors (CSTRs), the vessels may be an integral unit having multiple esterification zones with appropriate partitions and controls. Likewise, while the reaction zones are shown as separate vessels, which are typically CSTRs of the wipe film or thin film type, the vessels may be combined in one or more integral units having multiple polycondensation zones with appropriate partitions and controls. Various other types of esterification and polycondensation reactors as well as reactor arrangements are known in the art and may be adapted for use in accordance with the present disclosure.

Referring to FIG. 6, in one embodiment, a paste that is made up of EG and TPA in a 2:1 mole ratio with recycled copolyesters and/or polyesters is fed into the location labeled as the Paste Tank. Additional EG is fed into the first reaction zone or reactor 1 and other glycols such as CHDM, TMCD, NPG, and DEG can also be fed into the first reaction zone based on the targeted final composition of the copolyester at the same location and optionally, additional recycled material can be added. In one embodiment, these raw materials may be added separately and/or directly into the first reaction zone. In some embodiments, recycled copolyesters and/or polyesters are fed into at least one of the following locations the Paste Tank, Zone #1, Zone #2 or the Finishing Zone. In some embodiments, recycled copolyesters and/or polyesters are fed into one or more of the following locations the Paste Tank, Zone #1, Zone #2 or the Finishing Zone.

The reaction mixture in the first reaction zone is heated via a recycle loop that includes a heat exchanger. Esterification takes place in the first reaction zone to form a first esterification product comprising copolyester monomers, oligomers, or both and unreacted TPA, EG, and other glycols such as CHDM, TMCD, NPG or DEG. The reaction product of the first reaction zone is then passed to a second reaction zone. Further esterification takes place in the second reaction zone to form a second esterification product comprising additional copolyester monomers, oligomers, or both.

In some embodiments, the average chain length of the monomers and/or oligomers exiting the esterification stage can be less than 25, from 1 to 20, or from 5 to 15.

In one embodiment, the second reaction zone is optional. In some embodiments the product passes from the first reaction zone to a third reaction zone.

The reaction product of the second reaction zone is then passed to a third reaction zone. In some embodiments, polycondensation optionally in the presence of a polycondensation catalyst takes place in the third reaction zone to form a prepolymerization product comprising copolyester oligomers. In some embodiments, polycondensation takes place in the third reaction zone without the need for a polycondensation catalyst to form a prepolymerization product comprising copolyester oligomers In some embodiments, the catalysts residues remaining from the recycled copolyesters and polyesters is sufficient to act as the polycondensation catalyst. In some embodiments, the third reaction zone converts the monomers exiting the esterification stage into oligomers having an average chain length in the range of 2 to 40, 5 to 35, or 10 to 30.

The prepolymerization product is then passed to one or more reaction zones or finishing zones. Additional polycondensation optionally in the presence of the polycondensation catalyst takes place in the finishing zones to form a copolyester with the desired average chain length or IV. The copolyester is then withdrawn from the finishing zone for subsequent processing, such as formation into pellets via an extruder connected to an underwater pelletizer.

In one embodiment, the temperature in the paste tank is between 120-180° C.

In one embodiment, the temperature in the glycolysis and transesterification zone is 200-300° C.

In one embodiment, the reacting step is carried out at a melt temperature of at least 253° C., at least 255° C., or at least 257° C. In one embodiment, additionally or alternatively, the reacting step is carried out at a melt temperature of not more than 290° C., not more than 285° C., not more than 280° C., not more than 275° C., not more than 270° C., or not more than 265° C. In various embodiments, the reacting step is carried out at a melt temperature of 250 to 270° C., or 257 to 265° C.

In one embodiment, the reacting step is carried out at a pressure of 25 to 40 psi, or 30 to 40 psig.

In one embodiment, the esterification step is carried out at a melt temperature of at least 253° C., at least 255° C., or at least 257° C. In one embodiment, additionally or alternatively, the esterification step is carried out at a melt temperature of not more than 290° C., not more than 285° C., not more than 280° C., not more than 275° C., not more than 270° C., or not more than 265° C. In various embodiments, the esterification step is carried out at a melt temperature of 250 to 270° C., or 257 to 265° C.

In one embodiment, the esterifying step (d) is carried out at a pressure of 8 to 20 psig.

In one embodiment, the average residence time of the reactants in the reacting step is 2 hours or less, 1.75 hours or less, 1.5 hours or less, 1.25 hours or less, 1 hour or less, or 0.75 hours or less. In various embodiments, the average residence time of the reactants in the reacting step is 30 to 40 minutes.

In one embodiment, the average residence time of the reactants in the esterifying step is 2 hours or less, 1.75 hours or less, 1.5 hours or less, 1.25 hours or less, 1 hour or less, or 0.75 hours or less. In various embodiments, the average residence time of the reactants in the esterifying step (d) is 30 to 40 minutes.

In various embodiments, the overall molar ratio of EG:TPA introduced into the process ranges from 2.3:1 to 3.0:1.

In various embodiments, the overall molar ratio of EG:TPA introduced into the process ranges from 2.3:1 to 2.71:1.

The temperature, pressure, and average residence time of the reacting step in the first reaction zone are those described above.

In various embodiments, the reacting step in the first reaction zone is carried out at a melt temperature of 250 to 270° C. and a pressure of 25 to 40 psi.

In various embodiments, the reacting step in the first reaction zone is carried out at a melt temperature of 257 to 265° C. and a pressure of 30 to 40 psi.

The temperature, pressure, and average residence time of the esterify step in the second reaction zone may be those described above.

In various embodiments, the esterifying step in the second reaction zone is carried out at a melt temperature of 250 to 270° C. and a pressure of 8 to 20 psi.

In various embodiments, the esterifying step in the second reaction zone is carried out at a melt temperature of 257 to 265° C. and a pressure of 8 to 20 psi.

Polycondensation catalysts useful in the processes of the present disclosure are not particularly limiting. Examples of such catalysts include titanium-based compounds, antimony-based compounds, and germanium-based compounds. Titanium catalysts are very efficient and offer high polycondensation rates at low catalyst levels. The polycondensation catalysts may be added either during the esterification stage or the polycondensation stage. In one embodiment, they are added with the feed materials into the first reaction zone. In one embodiment, the catalyst is added in the range of 1 to 500 ppm, based on the weight of the copolyester. In one embodiment, in the case of titanium, the catalyst may be added in the range of 1 to 50 ppm, based on the weight of the copolyester.

In one embodiment, the catalysts choice is affected by the catalysts that originate from the recycled feed. Specific catalytic advantages are achieved by the combination of catalysts from the feed and catalysts added to the first reaction zone and the second reaction zone. Catalysts likely coming from rPET include Sb, and Li/Al. Catalysts coming from rPETG could be Ti, Co, Ge, and Sb. Catalysts coming from rPETM and rPCTM include Co.

In some embodiments, phosphorus compounds are often added, along with the catalyst, to improve thermal stability. Phosphorus compounds useful as thermal stabilizers include phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. In some embodiments, suitable thermal stabilizers include triphenyl phosphate Merpol A. In one embodiment, phosphorus is added in the range of 10 to 100 ppm, based on the weight of the copolyester.

In various embodiments, one or more other additives can be added to the starting materials, the copolyesters, and/or the copolyester monomers/oligomers at one or more locations within the process. In various embodiments, suitable additives can include, for example, trifunctional or tetrafunctional comonomers, such as trimellitic anhydride, trimethylolpropane, pyromellitic dianhydride, pentaerythritol, or other polyacids or polyols; crosslinking or other branching agents; colorants; toners; pigments; carbon black; glass fibers; fillers; impact modifiers; antioxidants; UV absorbent compounds; oxygen scavenging compound; etc.

The processes according to this disclosure are particularly suitable for use on an industrial scale. For example, in one embodiment, they may be practiced on commercial production lines capable of running at rates of 500 to 30,000 lbs/hr of polymer.

In another aspect, this disclosure relates to copolyesters produced from the processes of this disclosure.

In still further accordance with the foregoing process, the new polyester product may contain ethylene glycol, diethylene glycol, and 1,4-cyclohexanedimethanol diol units, with the 1,4-cyclohexanedimethanol units comprising up to about 25 mol % of the total of the diol units and diethylene glycol comprising up to 15 mol % of the total diol units. In this case, the 1,4-cyclohexanedimethanol and diethylene glycol units may be added directly to a part of ethylene glycol component in the first reaction mixture or originate from a part of the postconsumer poly(ethylene terephthalate) or glycol-modified poly(ethylene terephthalate) flake material.

In various embodiments, the copolyester comprises:
(a) a diacid component comprising 60-100 mol % of residues of terephthalic acid, isophthalic acid, or mixtures thereof; and
(b) a diol component comprising 0-96.5 mol % of residues of ethylene glycol and 3.5 to 100 mol % of residues of 1,4-cyclohexanedimethanol,
wherein the diacid component is based on 100 mol % of total diacid residues in the copolyester and the diol component is based on 100 mol % of total diol residues in the copolyester.

In various embodiments, the copolyester comprises:

(a) a diacid component comprising 90 to 100 mol % of residues of terephthalic acid; and
(b) a diol component comprising 50 to 96.5 mol % of residues of ethylene glycol and 3.5 to 50 mol % of residues of 1,4-cyclohexanedimethanol,
wherein the diacid component is based on 100 mol % of total diacid residues in the copolyester and the diol component is based on 100 mol % of total diol residues in the copolyester.

In various embodiments, the copolyester comprises:
(a) a diacid component comprising 90 to 100 mol % of residues of terephthalic acid; and
(b) a diol component comprising 0 to 50 mol % of residues of ethylene glycol and 50 to 100 mol % of residues of 1,4-cyclohexanedimethanol,
wherein the diacid component is based on 100 mol % of total diacid residues in the copolyester and the diol component is based on 100 mol % of total diol residues in the copolyester.

In various embodiments, the copolyester comprises:
(a) a diacid component comprising 60 to 100 mol % of residues of terephthalic acid; and
(b) a diol component comprising 65 to 85 mol % of residues of ethylene glycol and 25 to 35 mol % of residues of 1,4-cyclohexanedimethanol,
wherein the diacid component is based on 100 mol % of total diacid residues in the copolyester and the diol component is based on 100 mol % of total diol residues in the copolyester.

In various embodiments, the copolyester has an inherent viscosity of 0.4 to 1.5 dL/g or 0.5 to 1.2dL/g or 0.6 to 0.9 dL/g.

In various other embodiments, the copolyester comprises:
(a) a diacid component comprising 100 mol % of residues of terephthalic acid, isophthalic acid, or mixtures thereof;
(b) a diol component comprising 0 to 96.5 mol % of residues of ethylene glycol, 3.5 to 100 mol % of residues of 1,4-cyclohexanedimethanol, and 0 to 0.4 mol % of residues of trimellitic anhydride; and
wherein the copolyester has an inherent viscosity (IV) of 0.4 to 1.5 dL/g,
wherein all weight percentages are based on the total weight of the copolyester; and
wherein the diacid component is based on 100 mol % of total diacid residues in the copolyester and the diol component is based on 100 mol % of total diol residues in the copolyester.

In one embodiment, the present disclosure includes an article of manufacture or a shaped article comprising the shrink films of any of the shrink film embodiments of this disclosure. In another embodiment, the present disclosure includes an article of manufacture or a shaped article comprising the oriented films of any of the oriented film embodiments of this disclosure.

In certain embodiments, the present disclosure includes but is not limited to shrink films applied to containers, plastic bottles, glass bottles, packaging, batteries, hot fill containers, and/or industrial articles or other applications. In one embodiment, the present disclosure includes but is not limited to oriented films applied to containers, packaging, plastic bottles, glass bottles, photo substrates such as paper, batteries, hot fill containers, and/or industrial articles or other applications.

In certain embodiments of the present disclosure, the shrink films of this disclosure can be formed into a label or sleeve. The label or sleeve can then be applied to an article of manufacture, such as, the wall of a container, battery, or onto a sheet or film.

The oriented films or shrink films of the present disclosure can be applied to shaped articles, such as, sheets, films, tubes, bottles and are commonly used in various packaging applications. For example, films and sheets produced from polymers such as polyolefins, polystyrene, poly(vinyl chloride), polyesters, polylactic acid (PLA) and the like are used frequently for the manufacture of shrink labels for plastic beverage or food containers. For example, the shrink films of the present disclosure can be used in many packaging applications where the shrink film applied to the shaped article exhibits properties, such as, good printability, high opacity, higher shrink force, good texture, and good stiffness.

The combination of the improved shrink properties as well as the improved toughness should offer new commercial options, including but not limited to, shrink films applied to containers, plastic bottles, glass bottles, packaging, batteries, hot fill containers, and/or industrial articles or other applications.

Additionally, the materials of this disclosure can be extruded into sheet and the sheet can be further thermoformed into 3-dimensional articles. The materials of this disclosure can be converted into molded articles, film, shrinkable films, oriented films, blow molded articles, and blown film articles.

The present disclosure includes and expressly contemplates and discloses any and all combinations of embodiments, features, characteristics, parameters, and/or ranges mentioned herein. That is, the subject matter of the present disclosure may be defined by any combination of embodiments, features, characteristics, parameters, and/or ranges mentioned herein.

Any process/method, apparatus, compound, composition, embodiment, or component of the present disclosure may be modified by the transitional terms “comprising,” “consisting essentially of,” or “consisting of,” or variations of those terms.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein should be considered as approximations, unless the context indicates otherwise. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

This disclosure can be further illustrated by the following working examples, although it should be understood that these examples are included merely for purposes of illustration and are not intended to limit the scope of the present disclosure. Unless indicated otherwise, parts are parts by weight, temperature is in degrees C. (Celsius) or is at room temperature, and pressure is at or near atmospheric.

### EXAMPLES

This disclosure can be further illustrated by the following examples of embodiments thereof, although it will be understood that these examples are included merely for purposes of illustration and are not intended to limit the scope of the disclosure unless otherwise specifically indicated.

### Comparative Example 1

The shrink film properties of a standard polyester shrink film resin (Sample SPR) is shown in Table 1 (this standard resin is commercially available from Eastman Chemical Company). Shrink films made using this standard shrink film resin is comparative example #1.

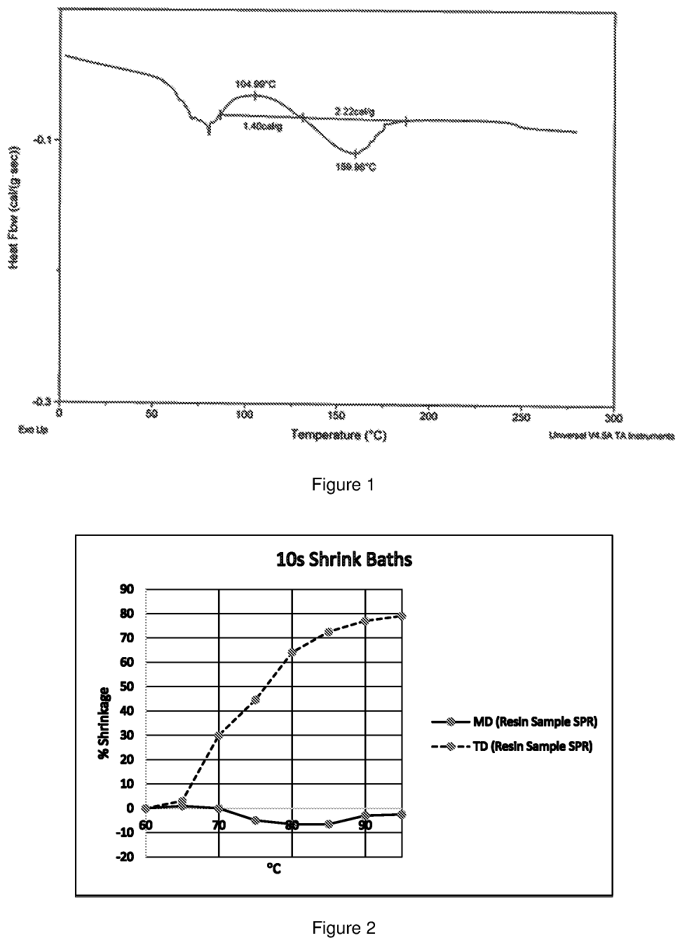

Shrinkage properties are shown in FIG. 2 where shrinkage is measured in the main shrinkage direction (TD direction) and in the direction orthogonal to the main shrinkage direction (MD direction) at temperatures ranging from 60 to 95° C. The strain induced crystalline melting point is measured using a Differential Scanning calorimeter (DSC) (FIG. 1) on film that has been stretched. Pellet samples can also be crystallized in an oven for 2 h at 170° C. to assess crystallinity in the sample. The strain induced crystalline melting point is measured on the 1^{st} heat with a heating rate of 20° C./min, but the resins described in this disclosure typically do not have a crystalline melting point that can be measured on the 2^{nd} heat of the DSC procedure with a heating rate of 20° C./min.

TABLE 1

| Resin Sample SPR | Values |
|---|---|
| PTA content (mole %) | 100 |
| EG content (mole %) | 65 |
| CHDM (mole %) | 23 |
| DEG content (mole %) | 12 |
| Film thickness (microns) | 50 |
| Ultimate shrinkage (% at 95 C.) | 80 |
| Shrink Force (Mpa) | 6 |
| Tg (° C.) | 70 |
| Strain induced crystalline melting point (° C.) | 160 |
| Elongation @ break (%, at 300 mm/min) | 450 |
| Elongation @ break (%, at 500 mm/min) | 30 |

The Association for Plastic Recyclers (APR) has established a test for measuring whether a material is compatible with the current recycling process (PET-CG-03). Using this test method, labels (minimum 3% by weight) and bottles are ground to a ¼″ to ½″ flake size. The bottle flake was then blended 50:50 with unlabeled control bottle flake. The sample was then elutriated on a setting that allows no more than 1.2% of the PET to be carried over with label. The flake was washed with 0.3% Triton X-100 and 1.0% caustic for 15 minutes at 88° C. The flake was then washed with water after removing all floating material and then strained to remove excess water. The flake was elutriated again just as before. Then 2 lbs of washed flake was placed in a Teflon-lined baking dish for each washed sampled and the flake was added to a layer thickness of 1.5 inches. The pan containing the flake was place in a circulating oven at 208° C. for 1½ hours. The flake was cooled and then passed through a sieve with 0.0625 inch openings. As the material was passed through the sieve, no material should clump and therefore become too large to pass through the sieve. This testing was followed by extrusion/pelletization and molding steps to ensure quality of the flake.

The film sample described in Table 1 creates >1% by weight of clumped PET flake using this APR test, and therefore would be approved for use in the recycling of PET. As such, labels made with this type of resin must be removed before the PET recycling process to eliminate clumping of PET flake after processing. The crystallizable film compositions in this disclosure, however, provide an advantage for the recycling process because the crystallizable films are more compatible with the recycling process, and can be recycled with the PET flake.

The crystallizable compositions described in this disclosure were designed to be compatible with the recycling process. To be compatible with the recycling process, the crystallizable films are designed in such a way, that they do not become “sticky” during the drying step at 208° C. as described in the APR test. However, the films must also meet the performance criteria typically required for shrinkable films (high ultimate shrinkage, low to negative MD shrinkage, etc.). To meet both of these requirements, recyclability and good shrinkage properties, the polyester compositions must be amorphous, i.e. the compositions do not contain crystallinity when measured using DSC 2^{nd} heat with a heating rate of 20° C. per minute. However, after stretching, films made with the optimized polyester resin compositions should contain a broad strain induced crystalline melting peak above 200° C. as measured during the 1^{st} heat with a DSC running with a heating rate of 20° C. per minute. This level of strain induced crystallinity prevents stickiness during the drying step with recycled PET flake. As such, the optimized polyester resin compositions of this disclosure can be described as amorphous but crystallizable.

The following examples further illustrate how the polyesters of the present disclosure can be made and evaluated, and they are intended to be purely exemplary and are not intended to limit the scope thereof. Unless indicated otherwise, parts are parts by weight, temperature is in degrees C. (Celsius) or is at room temperature, and pressure is at or near atmospheric.

This disclosure can be further illustrated by the following examples of preferred embodiments thereof, although it will be understood that these examples are included merely for purposes of illustration and are not intended to limit the scope of the disclosure unless otherwise specifically indicated.

### Example 1

To better understand these performance targets, a series of copolyesters were made with various CHDM and DEG content using procedures well known to those skilled in the art of making polyesters. Once synthesized, the resins were ground into powder, and then pressed into 10 mil film samples using a heated press. The pressed films were then stretched using a Bruckner Film Stretcher so that shrink film properties could be measured. The ground samples were crystallized in a forced air oven for 2 h at 170° C. so that the crystalline melting point could be measured. This crystallized sample was used as a proxy for the strain induced crystalline melting peak that will be present after stretching. Table 2 is a summary of the experimental details. Comparative example 1 (film #L-1/resin sample SPR) was also made and evaluated as a control.

TABLE 2

| | | | | Amorphous | | Tg | Tm | Tm (° C.) | Tm (C) |
|---|---|---|---|---|---|---|---|---|---|
| | | | | monomer | IV | (° C.), | (° C.), | after heat | after |
| Film # | EG | CHDM | DEG | content | (dL/g) | 2^{nd} Heat | 2^{nd} Heat | treatment | stretching |
| L-1 | 65 | 23 | 12 | 35 | 0.91 | 77 | None | 165 | N/A |
| L-2 | 72 | 23 | 5 | 28 | 0.824 | 77 | None | 187 | 182 |
| L-3 | 76 | 19 | 5 | 24 | 0.926 | 76 | None | 188 | 194 |
| L-4 | 76 | 16 | 8 | 24 | 0.922 | 74 | None | 189 | 194 |
| L-5 | 79 | 16 | 5 | 21 | 0.781 | 76 | None | 206 | 205 |
| L-6 | 82 | 16 | 2 | 18 | 0.924 | 78 | None | 206 | 208 |

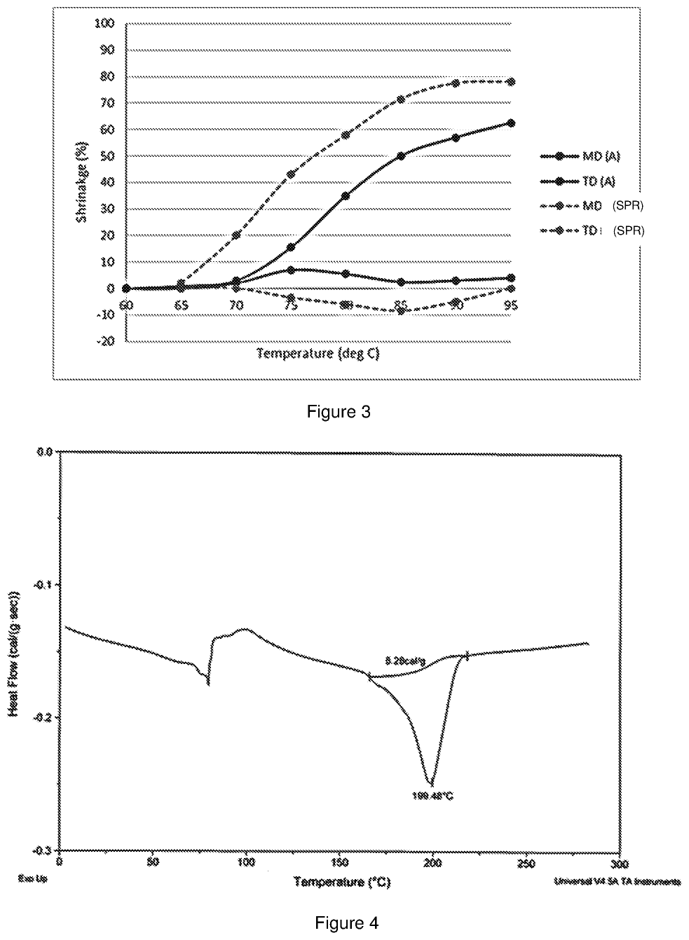

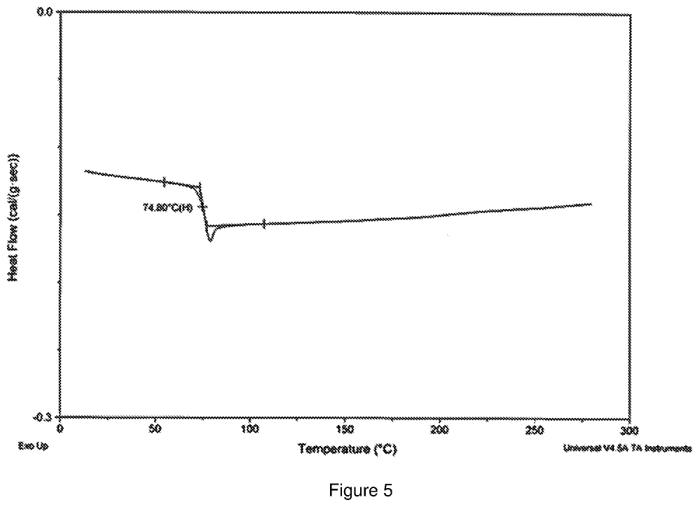

The data in Table 2 shows that resin samples with an amorphous monomer content (in this case, DEG+CHDM) less than 24 have a crystalline melting peak above 200° C. after heat treatment. The composition for film #L-5 was then scaled up in a larger reactor and used to make a shrink film on a commercial tenter frame. The shrinkage properties of this film are shown in FIG. 3 along with a sample of comparative example 1 (resin SPR). The composition of film A was the same as film #L-5.

TABLE 3

| | SPR | A (CZ-2) |
|---|---|---|
| PTA content (mole %) | 100 | 100 |
| EG content (mole %) | 64 | 76 |
| CHDM (mole %) | 23 | 17 |
| DEG content (mole %) | 12 | 6 |
| Total Amorphous Monomer Content | 35 | 23 |
| Film thickness (microns) | 50 | 50 |
| Ultimate shrinkage (% at 95 C.) | 80 | 63 |
| MD Shrinkage @ 75 C. (%) | −5 | 7 |
| Shrink Force (Mpa) | 8.5 | 8 |
| Tg (° C.) | 69 | 74 |
| Strain induced crystalline melting point (° C.) | 161 | 194 |
| Elongation @ break (%, at 300 mm/min) | 459 | 451 |
| Elongation @ break (%, at 500 mm/min) | 35 | 580 |

Table 3 is a summary of the comparison of Sample SPR and Film Sample A. From this data, the Film A composition does not shrink in a similar manner to the comparative example #1. The ultimate shrinkage (shrinkage in main shrinkage direction or TD at 95 C), is 17% lower than comparative example #1. Additionally, the shrinkage in the direction orthogonal to the main shrinkage direction (MD shrinkage), is actually positive (7%) for the Sample A compared to comparative example #1. Positive MD shrinkage is not preferred.

### Example 2

Neopentyl glycol (NPG) is another glycol monomer capable of forming amorphous copolyester compositions. It was believed that adding NPG in substitution for CHDM may reduce MD shrinkage. To study this effect in more detail, another resin sample was made, similar in composition, but contained NPG in place of CHDM. The new resin sample was then blended with the resin used to make L-5 to study the effect of the monomer substitution. These resins were extruded into a 10 mil film and then stretched on the Bruckner film stretcher. Testing of these films revealed the following results. When the CHDM content is less than 8 mole %, the MD shrinkage is 0% at 75° C. As the CHDM content is reduced further, the MD shrinkage becomes negative, indicating film growth instead of shrinkage. Additionally, the effect of amorphous monomer content is confirmed. All samples shown in Table 4 have an amorphous monomer content>23. Subsequently, the strain induced crystalline melting point for these compositions was <200° C. This strain induced crystalline melting point<200° C. is too low to pass the APR test. Typically, the strain induced crystalline melting point should be >200° C. to pass the APR test. From this study it was determined that the amorphous monomer must be further decreased to ensure a strain induced crystalline melting point>200° C. And in some instances the CHDM content should be less than 10 mole % to ensure films made with the resin have minimal shrinkage in the direction orthogonal to the main shrinkage direction (MD direction).

TABLE 4

| | | | | | Amorphous | | |
|---|---|---|---|---|---|---|---|
| | | | | | Monomer | | Tm |
| | CHDM | NPG | DEG | EG | Content | MD % | (1^{st} Heat) |
| Film # | (mole %) | (mole %) | (mole %) | (mole %) | (mole %) | @75° C. | (° C.) |
| 1 | 0 | 16 | 8.0 | 76.0 | 24 | −0.5 | 189 |
| 2 | 8.6 | 7.8 | 7.6 | 76.0 | 24 | −1.5 | 191 |
| 3 | 10.1 | 6.3 | 7.4 | 76.2 | 24 | 0 | 191 |
| 4 | 11.8 | 4.6 | 7.2 | 76.4 | 24 | 0.5 | 192 |
| 5 | 14.4 | 2.1 | 7.0 | 76.5 | 24 | 2 | 193 |
| 6 (L-5) | 16.3 | 0 | 7.0 | 76.7 | 23 | 4 | 193 |

### Example 3

A series of resins were then made, extruded into 10 mil films using a 2.5″ Davis and Standard extruder, stretched and then evaluated for their shrink film performance to compare shrinkage properties and crystallinity. Details of these resin compositions and performance of shrink films made from these resin compositions is shown in Table 5. From this analysis, an optimized resin composition was designed that would give a low MD shrinkage at 75° C. and a strain induced crystalline melting point>200° C. This optimized resin composition contains 10 mole % NPG and 5 mole % CHDM and 5 mole % DEG. Again, it was determined that resins that contain an amorphous monomer content<24 mole % have a strain induced crystalline melting point equal to or greater than 200° C. Also, when the CHDM monomer content is less than 10 mole %, the MD shrinkage is minimized.

TABLE 5

| | | M | I | I | GP |
|---|---|---|---|---|---|
| | N | (-058) | (-059) | (106) | (C-A17) |
| PTA content (mole %) | 100 | 100 | 100 | 100 | 100 |
| EG content (mole %) | 80 | 79 | 79 | 76 | 71 |
| NPG (mole %) | 10 | 0 | 16 | 16 | 26 |
| CHDM (mole %) | 5 | 15 | 0 | 0 | 0 |
| DEG content (mole %) | 5 | 5 | 5 | 8 | 3 |
| Total Amorphous Monomer | 20 | 20 | 21 | 24 | 29 |
| Content | | | | | |
| Film thickness (microns) | 50 | 50 | 50 | 50 | 50 |
| Ultimate shrinkage | 59 | 57 | 65 | 59 | 79 |
| (% at 95° C.) | | | | | |
| MD Shrinkage @ | 1.5 | 4 | 0 | 0 | −5 |
| 75° C. (%) | | | | | |
| Shrink Force (Mpa) | 9 | 9 | 9 | 8 | 10 |
| Tg (° C.) | 75 | 76 | 74 | 71 | 76 |
| Strain induced crystalline | 200 | 201 | 196 | 187 | 177 |
| melting point (° C.) | | | | | |
| Elongation @ break | 588 | 643 | 552 | 619 | 380 |
| (%, at 300 mm/min) | | | | | |
| Elongation @ break | 675 | 636 | 493 | 505 | 367 |
| (%, at 500 mm/min) | | | | | |

TABLE 6

| | | I | I | I | GP | O |
|---|---|---|---|---|---|---|
| | N | (-045) | (-059) | (106) | (C-A17) | (-063) |
| PTA content (mole %) | 100 | 100 | 100 | 100 | 100 | 100 |
| EG content (mole %) | 80 | 78 | 79 | 76 | 71 | 79 |
| NPG (mole %) | 10 | 16 | 16 | 16 | 26 | 13 |
| CHDM (mole %) | 5 | 0 | 0 | 0 | 0 | 3 |
| DEG content (mole %) | 5 | 6 | 5 | 8 | 3 | 6 |
| Total Amorphous | 20 | 22 | 21 | 24 | 29 | 22 |
| Monomer Content | | | | | | |
| Film thickness (microns) | 50 | 50 | 50 | 50 | 50 | 50 |
| Ultimate shrinkage (% at | 66 | 71 | 72 | 71 | 79 | 70 |
| 95 C.) | | | | | | |
| MD Shrinkage @ 75 C. (%) | 2 | −2 | −2 | −1 | −5 | −0.5 |
| Shrink Force (Mpa) | 11 | 9 | 9.7 | 10 | 10 | 9.5 |
| Tg (° C.) | 75 | 71 | 73.5 | 71 | 75.7 | 73 |
| Strain induced crystalline | 200 | 189 | 194 | 189 | 177 | 195 |
| melting point (° C.) | | | | | | |
| Elongation @ break (%, at | 588 | 648 | 656 | 626 | 380 | |
| 300 mm/min) | | | | | | |
| Elongation @ break (%, at | 675 | 690 | 532 | 712 | 357 | |
| 500 mm/min) | | | | | | |

### Example 4

Several of these resins were then tested in a clump test to mimic the APR-protocol to assess the impact of melting point (Tm) on clumping. Parameters of the clump test are as follows:
˜135 g PET flake per sample; ˜3.4 g shrink film in its shrunk state (2.5% film with flake)
PET flake+film was placed in an aluminum pan to achieve a depth of 1.5 inches.
The pan with the flake was place in a forced air oven at 208° C. Oven Temp for 1.5 hour.

Results from these tests are described in Table 7

TABLE 7

| | Tm | Score (1-10, |
|---|---|---|
| Film | (° C.) | 10 is no clumping) |
| 045 | 188 | 5 |
| 059 | 196 | 4 |
| 058 | 201 | 8 |
| Comparative ex 1 (SPR) | 165 | 2 |

### Comparative Example 2

Films made from these compositions that had an amorphous monomer content is less than 20 (and hence the DEG content is less than 12) were also extremely tough. Toughness for these films is measured using ASTM D882. Films that have an elongation at break greater than 300% at a pull rate of 300 mm/min and also 500 mm/min are considered to be tough.

Other film constructions can be used to make these crystallizable polyester shrink film resins. For example, multilayer films can be made such that the core of the film is made with one, amorphous shrink film resin (e.g. comparative example #1), and the skins are made with the crystallizable shrink film resins of the present disclosure. With this structure, the shrink film properties are more similar to the core layer properties, but the skin provides a degree of crystallinity that could reduce the amount of clumping during recycling. Blends of various commercial resin compositions can also be made to duplicate the resin composition of a reactor grade resin. In each case, the performance of the resulting shrink film must be evaluated for efficacy in shrink film applications. These shrink film concepts are described in Table 12. These films were made on a commercial tenter frame and evaluated for performance in these shrink film applications.

Standard Samples E21, Sample E12, Sample SP, and Sample SPR were evaluated. All standard samples evaluated are commercially available from Eastman Chemical company. Sample E226, Sample E213, Sample E2616 were made in the lab using procedures well known to those skilled in the art of making copolyesters.

TABLE 12

| Measured Shrink Film properties | Core Layer | Cap Layer |
|---|---|---|
| SPR | Sample SPR | None |
| E21 | Sample SPR | Sample E21 |
| Sample E213 Cap | Sample SPR | Sample E213 |

TABLE 13

| Blend | | | | | |
|---|---|---|---|---|---|
| components | Sample | SAMPLE | Sample | Sample | Sample |
| (%) | SP | E226 | E12 | E21 | E2616 |
| Blend #1 | 20 | 40 | 4 | 36 | |
| Blend #2 | | 40 | | | 60 |
| Blend #3 | | 50 | | | 50 |
| Blend #4 | | 60 | | | 40 |

TABLE 14

| | | Sample | Sample | Blended | | | |
|---|---|---|---|---|---|---|---|
| Measured Shrink | Sample | E21 cap | E213 cap | monolayer | | | |
| Film properties | SPR | layer | layer | #1 | #2 | #3 | #4 |
| PTA content (mole %) | 100 | 100 | 100 | 100 | 100 | 100 | 100 |
| EG content (mole %) | 65 | 67 | 67 | 79 | 81 | 79 | 78 |
| NPG (mole %) | 0 | 0 | 1.2 | 13 | 11 | 13.5 | 15.5 |
| CHDM (mole %) | 23 | 20.8 | 22 | 3 | 3 | 2.4 | 2.1 |
| DEG content (mole %) | 12 | 11 | 11 | 5 | 5.1 | 4.6 | 4.3 |
| Total Amorphous | 35 | 31.5 | 33.5 | 21 | 18.6 | 20.5 | 21.9 |
| Monomer Content | | | | | | | |
| Film thickness | 50 | 50 | 50 | 50 | 50 | 50 | 50 |
| (microns) | | | | | | | |
| Ultimate shrinkage | 79 | 76 | 77 | 71 | 59 | 64 | 68 |
| (% at 95 C.) | | | | | | | |
| MD Shrinkage @ | −5 | 2 | −4 | 6 | 2.5 | 1.5 | 0 |
| 75 C. (%) | | | | | | | |
| Shrink Force (Mpa) | 5.9 | 6.4 | 6.7 | 10.3 | 8.2 | 9.2 | 9.5 |
| Tg (° C.) | 69 | 69.5 | 69.1 | 73.2 | 75 | 75.5 | 75.5 |
| Strain induced | 160 | 156, 239 | 159 | 234 | 225 | 225 | 224 |
| crystalline | | | | | | | |
| melting point (° C.) | | | | | | | |

As can be seen in these blend examples, many of the properties of the resulting shrink film meet the desired properties for the compositions of the present disclosure. However, two of the film examples have significant MD shrinkage at 75° C. But, the strain induced crystalline melting points are higher for these examples (235-240° C.). This higher strain induced crystalline melting points could be advantageous in applications where higher melting points are required, but these higher melting points come with higher MD shrinkage so a balance of properties must be achieved.

### Experimental Details

Resin samples were dried in a desiccant drier at 60° C., and then blended and extruded into film using two different processes. In the lab-scale extruder process, films with a thickness of 10 mils (250 microns) were extruded using a 2.5″ Davis and Standard extruder. Once extruded, the films were cut and stretched on a Bruckner Karo 4 tenter frame to approximately a 5:1 stretch ratio and to a final thickness of 50 microns at a temperature 10-15 degrees above Tg. In the commercial process, the films were made on a commercial tenter line where the extruded film is stretched directly after extrusion. These films were stretched under approximately the same conditions as the films made with the lab-scale process to about a 5:1 stretch ratio and to a thickness of 50 microns.

In the lab-scale pressed film process, resin is dried overnight (approximately 12 hours) under vacuum in an oven that is set to a temperature slightly below the Tg of the material. After drying, 8.00 g of resin is weighed out and placed between two metallic plates according to the following configuration: plate—Kapton film—resin enclosed by a square 10 mil shim—Kapton film—plate. Before inserting this configuration into the press, the press platens are heated to approximately 100 C above the Tm of the resin. The configuration is then inserted between the platens of the press, and enough force is exerted on the plates to allow complete melting of the resin. The resin is allowed to melt for 3 minutes before increasing pressure to 12,000 psi for 1.5 minutes. A “bubble bump” procedure is performed next: release pressure from 12,000 psi to 0 psi and increase to 13,000 psi; immediately release pressure again to 0 psi and increase to 14,000 psi; repeat in 1000 psi increments until 16,000 psi is achieved, and allow pressure to remain at 16,000 psi for 1.5 minutes. Afterwards, the resin/plate configuration is removed from the press and extracted from the shim using a razor blade. The result should be a 6x6 10 mil film ready for stretching on the Bruckner.

The glycol content of the extruded film compositions was determined via NMR. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. The acid component of the blended polymers used in the examples herein was 100 mole % terephthalic acid. The total mole percentages of the glycol component equaled 100 mole % and the total mole percentages of the acid component equaled 100 mole %.

The inherent viscosity of the polyesters herein was determined in 60/40 (wt/wt) phenol/tetrachloroethane at a concentration of 0.5 g/100 ml at 25° C., and is reported in dL/g.

Shrinkage is measured herein by placing a 100 mm by 100 mm square film sample in water from 65° C. to 95° C. for 10 seconds without restricting shrinkage in any direction. The percent shrinkage is then calculated by the following equation:

% shrinkage=[(100 mm-length after shrinkage)/100 mm]×100%.

Shrinkage was measured in the direction orthogonal to the main shrinkage direction (machine direction, MD) at and was also measured in the main shrinkage direction (transverse direction, TD).

Shrink force is measured for the examples herein with a LabThink FST-02 Thermal Shrinkage Tester in MPa.

Tensile film properties were measured for the examples herein using ASTM Method D882. Multiple film stretching speeds (300 mm/min and 500 mm/min) were used to evaluate the films.

The glass transition temperature and the strain induced crystalline melting point (Tg and Tm respectively) of the polyesters is determined using a TA DSC 2920 from Thermal Analyst Instrument at a scan rate of 20° C./min. Tm was measured on the first heat of stretched samples and Tg was measured during the 2^{nd} heating step. Additionally, samples could be crystallized in a forced air oven at 170° C. for 2 h and then analyzed with DSC. For all samples, a crystalline melting point is typically NOT present during the second heat of the DSC scan with a heating rate of 20° C./min.

The present disclosure has been described in detail with particular reference to preferred embodiments thereof, but it will be understood that variations and modifications can be effected within the spirit and scope of this disclosure.

### Laboratory Scale Process Results

General procedure: A mixture of 53.16 g of PTA, 62.21 g of EG, 2.97 g of DEG, 11.52 g of CHDM, and 18.86 g of rPET, was placed in a 500-milliliter flask equipped with an inlet for nitrogen, a metal stirrer, and a short distillation column. In addition, 0.14 ml of the Ti catalyst solution (targeting 16 ppm Ti) and 1 ml of the Mn solution (targeting 45 ppm Mn) were added to the flask. The flask was placed in a Wood's metal bath already heated to 200° C. The stirring speed was set to 200 RPM at the beginning of the experiment. The contents of the flask were heated at 200° C. for 60 minutes and then the temperature was gradually increased to 250° C. over 300 minutes. The reaction mixture was then heated to 270° C. for 20 minutes as the stirrer was slowed down to 100 rpm and a vacuum was gradually applied to 0.4 torr. The temperature was then increased to 278° C. over 20 minutes and stirring was reduced to 60 rpm, the mixture was held under these conditions for 120 minutes. After this hold, the mixture was returned to atmospheric pressure and removed from the heat. The polymer was then removed from the flask for analysis. Example 1 was made using 100% replacement of TPA with rPET. Example 2 was made with 20% rPET replacement of TPA.

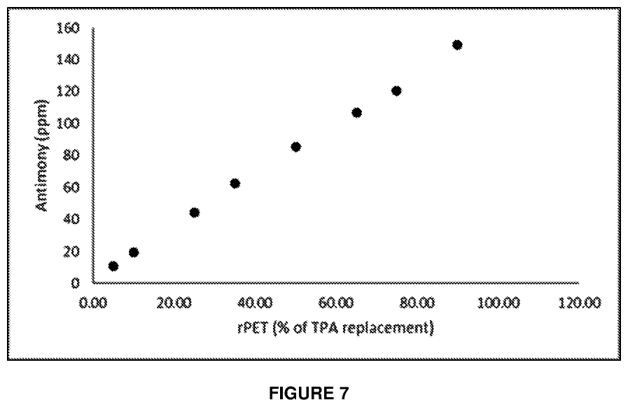

In one aspect of the present disclosure, given a reasonably constant supply of rPET the amount of Sb and other residual catalysts and additives can be predictable as shown in FIG. 7. In some embodiments, FIG. 7 illustrates that you can balance the amount of antimony you have to add to the system based on the amount of rPET you feed into the process. For example, if you want 100 ppm of Sb in the final product you could feed 60% rPET into the process or feed 20% rPET and add 60 ppm of Sb into the system.

### Laboratory Resin Characterization

| | | | Ti | P | Mn | Sb |
|---|---|---|---|---|---|---|
| Examples | IV | b* | ppm | ppm | ppm | ppm |
| 1 | 0.71 | 5.48 | 14.6 | 47.8 | 33.6 | 175.2 |
| 2 | 0.825 | 6.59 | 15.2 | 31.9 | 40.5 | 46.3 |

| | EG | DEG | CHDM | TEG |
|---|---|---|---|---|
| Examples | mole % | mole % | mole % | mole % |
| 1 | 75.3 | 9.3 | 15.1 | 0.3 |
| 2 | 69.6 | 11.8 | 18.1 | 0.5 |

The resins made in both cases were similar with respect to all critical performance criteria. Both materials had similar color, IV, and composition regardless of the amount of rPET that was added.

### Pilot Plant Process Results

Resin samples (A1 and A2) were made by adding 7.3 weight % recycled PET by weight to a reactor containing 45.7 weight % ethylene glycol, 0.7 weight % diethylene glycol, 9.8 weight % cyclohexane dimethanol, and 36.4 weight % terephthalic acid. A Ti catalyst was added at 30 ppm. The glycol to acid ratio was 3.3, with ethylene glycol and cyclohexane dimethanol used to make up the excess. The reaction mixture was held at 250-255° C. and 25-30 psig for 3-3.5 hours. Phosphorus was added at 21 ppm and then the reaction mixture was heated to 270° C. and stirred under vacuum until the target melt viscosity was reached.

A control resin sample (B) was made using the same process except that no rPET or DEG were added to the reaction mixture and 50ppm of Ti catalyst was used. 44.1 weight % ethylene glycol, 10.5 weight % cyclohexane dimethanol, and 45.5 weight % terephthalic acid were charged to a reactor. The glycol to acid ratio was 2.9, with ethylene glycol and cyclohexane dimethanol used to make up the excess. The CHDM excess was the same as the previous samples, while the EG excess decreased.

The characterization of the resins is described in the following Table.

### Pilot Plant Resin Characterization

| | | | Ti | P | Sb |
|---|---|---|---|---|---|
| Examples | IV | b* | ppm | ppm | ppm |
| A1 | 0.748 | 13 | 26.2 | 13.7 | 26.8 |
| A2 | 0.752 | 11.8 | 26 | 22 | 28 |
| B | 0.75 | 7.8 | 41 | 26 | <1 |

| | EG | DEG | CHDM | TEG | |
|---|---|---|---|---|---|
| Examples | mole % | mole % | mole % | mole % | CEG |
| A1 | 62.6 | 12.2 | 23 | 2.1 | 30.4 |
| A2 | 61.9 | 12.5 | 23.3 | 2.2 | 29.6 |
| B | 64 | 11.1 | 23 | 1.9 | 24.5 |

Resin examples A1 and A2 were combined to create resin A. Resins A and B were dried in a desiccant drier at 60° C. for 4-6 h. Films with a thickness of 10 mils (250 microns) were then extruded using a 2.5″ Davis and Standard extruder. Once extruded, the films were cut and stretched on a Bruckner Karo 4 tenter frame to a final thickness of 50 microns. The films were stretched at a 5:1 ratio, with a stretch rate of 100%/sec, and a stretch temperature 5-15 degrees Celsius above the Tg of the extruded film. Characterization of the shrinkable films made with this process is described in the following Table.

### Examples A and B: Shrinkable Films Made from Resin Compositions Made from rPET

| | | Example A | | Example B | |
|---|---|---|---|---|---|
| | Temp. | MD | TD | MD | TD |
| | (° C.) | (A) | (A) | (B) | (B) |
| Shrink | 60 | 0.0 | 3.0 | 0.0 | 2.0 |
| Bath Data | 65 | 0.5 | 18.0 | 2.0 | 13.5 |
| (10 s Shrink | 70 | −8.0 | 46.0 | −3.0 | 36.5 |
| Baths) | 75 | −14.0 | 61.0 | −8.5 | 56.0 |
| | 80 | −10.0 | 74.0 | −10.0 | 72.0 |
| | 85 | −8.5 | 78.0 | −7.5 | 77.0 |
| | 90 | −8.0 | 78.5 | −7.0 | 78.5 |
| | 95 | −10.0 | 78.5 | −6.0 | 79.0 |

| | | | |
|---|---|---|---|
| Shrink | MPa | 6.0 | 6.6 |
| Force | | | |
| IV | Extruded | 0.714 | 0.701 |
| | film, g/dL | | |
| DSC | Tg (° C.) | 67.5 | 68.4 |
| (Stretched) | Tm (° C.) | 149.7 | 157.1 |
| MD Break | 300 | 481 | 477 |
| Strain | mm/min, % | | |
| MD Break | 500 | 359 | 277 |
| Strain | mm/min, % | | |

Resins A and B had very similar compositions, IV, and color. The shrinkable films made with the resins also had very similar performance. These results demonstrate that incorporation of rPET into the resin manufacturing process does not affect the final performance of the resin or articles made from the resin.

### Commercial Scale Process

Resin samples were also made on commercial manufacturing equipment to demonstrate the utility of this invention.

In the commercial scale process, 5% recycled PET was added along with terephthalic acid and ethylene glycol to the slurry tank. The slurry tank was agitated for more than 30 min. to allow for adequate mixing. This slurry was then added to reaction zone 1 along with catalyst, additional ethylene glycol, diethylene glycol, and cyclohexanediol. This mixture was reacted for at least 1 h above 235° C. under 35+ psig of pressure to simultaneously depolymerize PET and react the monomers. Then monomers and oligomers from reaction zone 1were passed to reaction zone 2 where they were further reacted while stripping out additional glycols but maintaining reaction temperatures. This material passed into reaction zone 3 for finishing under higher temperature and deeper vacuum conditions. Characterization of the final product, Example C is shown in the following Table in comparison to another copolyester resin with the same composition also made in the commercial process without added rPET, Example D.

### Commercial Process Resin Characterization

| | | | Ti | P | Sb |
|---|---|---|---|---|---|
| Examples | IV | b* | ppm | ppm | ppm |
| C | 0.74 | 2.8 | 17.73 | 18.4 | 4.8 |
| D | 0.76 | 2 | 14.5 | 21.2 | 0.8 |

| | EG | DEG | CHDM | TEG |
|---|---|---|---|---|
| Examples | mole % | mole % | mole % | mole % |
| C | 63.56 | 11.83 | 23.54 | 1.08 |
| D | 64.56 | 11.56 | 22.90 | 0.7 |

Resins C and D were dried in a desiccant drier at 60° C. for 4-6 h. Films with a thickness of 10 mils (250 microns) were then extruded using a 2.5″ Davis and Standard extruder. Once extruded, the films were cut and stretched on a Bruckner Karo 4 tenter frame to a final thickness of 50 microns. The films were stretched at a 5:1 ratio, with a stretch rate of 100%/sec, and a stretch temperature 5-15 degrees Celsius above the Tg of the extruded film. Characterization of the shrinkable films made with this process is described in the following Table.

### Examples C and D: Shrinkable Films Made from Resin Compositions Made from rPET

| | | Example C | | Example D | |
|---|---|---|---|---|---|
| | Temp. | MD | TD | MD | TD |
| | (° C.) | (C) | (C) | (D) | (D) |
| Shrink | 60 | 0.5 | 1.5 | 0.0 | 1.0 |
| Bath Data | 65 | 2.0 | 8.0 | 1.0 | 12.0 |
| (10 s Shrink | 70 | −3.0 | 32.0 | −3.5 | 33.0 |
| Baths) | 75 | −10.0 | 56.0 | −11.0 | 52.0 |
| | 80 | −12.0 | 69.0 | −14.0 | 66.0 |
| | 85 | −11.5 | 76.0 | −12.5 | 76.0 |
| | 90 | −8.5 | 78.5 | −8.0 | 78.0 |
| | 95 | −10.5 | 79.0 | −12.0 | 78.0 |

| | | | |
|---|---|---|---|
| Shrink | MPa | 7.3 | 7.1 |
| Force | | | |
| IV | Extruded | 0.716 | 0.694 |
| | film, g/dL | | |
| DSC | Tg (° C.) | 69.7 | 69.1 |
| (Stretched) | Tm (° C.) | 161.2 | 160 |
| MD Break | 300 | 515 | 461 |
| Strain | mm/min, % | | |
| MD Break | 500 | 314 | 54 |
| Strain | mm/min, % | | |

Resins C and D had very similar compositions, IV, and color. The shrinkable films made with the resins also had very similar performance. These results demonstrate that incorporation of rPET into the resin manufacturing process does not affect the final performance of the resin or articles made from the resin.

This disclosure has been described in detail with particular reference to specific embodiments thereof, but it will be understood that variations and modifications can be made within the spirit and scope of this disclosure.

1. A process for producing a polyester composition from recycled polyesters comprising:
(a) introducing terephthalic acid (TPA); and ethylene glycol (EG); and recycled polyesters comprising one or more of recycled PET, recycled PETG, recycled PCT, recycled PCTA or recycled PCTG into a paste tank to form a slurry that is stirred and heated at temperatures up to 150° C.;
(b) passing the paste tank slurry to a first reaction zone;
(c) introducing at least one additional glycol comprising 1,4-cyclohexanedimethanol (CHDM), neopentyl glycol (NPG) or diethylene glycol (DEG), and optionally adding additional recycled polyesters comprising one or more of recycled PET, recycled PETG, recycled PCT, recycled PCTA or recycled PCTG; and optionally adding additional terephthalic acid (TPA); and ethylene glycol (EG) to a total glycol:TPA molar ratio of 1:1 to 4:1 into the first reaction zone, optionally in the presence of an esterification catalyst and/or a stabilizer;
(d) reacting the TPA and EG and the recycled polyesters with the at least one additional glycol in the first reaction zone at a melt temperature of at least 200° C. to form an esterification product comprising oligomers and unreacted TPA, EG, and the additional glycol(s);
(e) optionally passing the esterification product to a second reaction zone;
(f) reacting further the esterification product and optionally adding additional glycols comprising one or more of CHDM, NPG or DEG and/or additional recycled polyesters comprising one or more of recycled PET, recycled PETG, recycled PCT, recycled PCTA or recycled PCTG optionally in the second reaction zone at a melt temperature of at least 200° C. to form a resulting esterification product comprising polyester oligomers, optionally in the presence of an esterification catalyst and/or a stabilizer;
(g) passing the resulting esterification product, from one or multiple reaction zone(s) to a third reaction zone; and
(h) polycondensing the resulting esterification product in the third reaction zone and optionally adding additional recycled polyesters comprising one or more of recycled PET, recycled PETG, recycled PCT, recycled PCTA or recycled PCTG to form a polymerization product comprising polyesters, optionally in the presence of a polycondensation catalyst and/or a stabilizer.

2. (canceled)

3. A polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % neopentyl glycol residues;
(ii) about 0 to less than about 24 mole % 1,4-cyclohexanedimethanol residues;
(iii) about 1 to less than about 10 mole % total diethylene glycol residues in the final polyester composition;
wherein the total mole % of the dicarboxylic acid component is 100 mole %, and wherein the total mole % of the diol component is 100 mole %;
or
(b) a diol component comprising:
about 75 mole % or greater of ethylene glycol residues and
about 25 mole % or less of other glycols comprising one or more of:
(i) about 0.1 to less than about 24 mole % neopentyl glycol residues;
(ii) about 0.1 to less than about 24 mole % 1,4-cyclohexanedimethanol residues;
(iii) about 1 to less than about 10 mole % total diethylene glycol residues in the final polyester composition;
wherein the total mole % of the dicarboxylic acid component is 100 mole %, and wherein the total mole % of the diol component is 100 mole %.

4. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % neopentyl glycol residues;
(ii) about 0 to less than about 24 mole % 1,4-cyclohexanedimethanol residues;
(iii) about 1 to less than about 10 mole % total diethylene glycol residues in the final polyester composition;
wherein the total mole % of the dicarboxylic acid component is 100 mole %, and wherein the total mole % of the diol component is 100 mole %;
or
(b) a diol component comprising:
about 75 mole % or greater of ethylene glycol residues and
about 25 mole % or less of other glycols comprising one or more of:
(i) about 0.1 to less than about 24 mole % neopentyl glycol residues;
(ii) about 0.1 to less than about 24 mole % 1,4-cyclohexanedimethanol residues;
(iii) about 1 to less than about 10 mole % total diethylene glycol residues in the final polyester composition;
wherein the total mole % of the dicarboxylic acid component is 100 mole %, and wherein the total mole % of the diol component is 100 mole %.

5. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 15 mole % or less of neopentyl glycol residues;
(ii) about 5 mole % or less of 1,4-cyclohexanedimethanol residues;
(iii) about 5 mole % or less of total diethylene glycol residues in the final polyester composition;
wherein the total mole % of the dicarboxylic acid component is 100 mole %, and wherein the total mole % of the diol component is 100 mole %.

6. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 80 mole % or greater of ethylene glycol residues and
about 20 mole % or less of other glycols comprising one or more of:
(i) about 5 to less than about 17 mole % neopentyl glycol residues;
(ii) about 2 to less than about 10 mole/% 1,4-cyclohexanedimethanol residues;
(iii) about 1 to less than about 5 mole % total diethylene glycol residues in the final polyester composition;
wherein the total mole % of the dicarboxylic acid component is 100 mole %, and wherein the total mole % of the diol component is 100 mole %.

7. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 76 mole % or greater of ethylene glycol residues and
about 24 mole % or less of amorphous content comprising one or more of:
(i) neopentyl glycol residues;
(ii) cyclohexanedimethanol residues; and
(iii) diethylene glycol residues in the final polyester composition;
wherein the total mole % of the dicarboxylic acid component is 100 mole %, and wherein the total mole % of the diol component is 100 mole %.

8. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 10 to less than about 15 mole % neopentyl glycol residues;
(ii) about 1 to less than about 5 mole % 1,4-cyclohexanedimethanol residues;
(iii) about 1 to less than about 5 mole % total diethylene glycol residues in the final polyester composition;
wherein the total mole % of the dicarboxylic acid component is 100 mole %, and wherein the total mole % of the diol component is 100 mole %.

9. A crystallizable film or a thermoformed film or sheet comprising a polyester composition comprising:
at least one polyester produced from recycled polyesters by the process of claim 1, which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
(i) about 0 to about 30 mole % neopentyl glycol residues;
(ii) about 0 to about less than 30 mole % 1,4-cyclohexanedimethanol residues;
(iii) residues of diethylene glycol, whether or not formed in situ; and
wherein the remainder of the glycol component comprises:
(iv) residues of ethylene glycol, and
(v) optionally 0 to 10 mole %, or 0 to 5 mole % of the residues of at least one modifying glycol;
wherein the total mole % of the dicarboxylic acid component is 100 mole %, and wherein the total mole % of the glycol component is 100 mole %.

10. The crystallizable film or the thermoformed film or sheet of claim 4, wherein the inherent viscosity of the polyester is from 0.50 to 0.80 dL/g as determined in 60/40 (wt/wt) phenol/tetrachloroethane at a concentration of 0.25 g/50 ml at 25° C.

11. The crystallizable film or the thermoformed film or sheet of claim 4, wherein the polyester has a Tg of from 65° C. to 80° C. as determined using a TA DSC 2920 from Thermal Analyst Instrument at a scan rate of 20° C./min.

12. The crystallizable film or the thermoformed film or sheet of claim 4, wherein the sum of the diol content of one or more diol monomer components capable of forming an amorphous component in the final polyester is from 5 to 25 mole % wherein the total diol content is 100 mole %; or
wherein the sum of the diol content of one or more diol monomer components capable of forming an amorphous component in the final polyester is from 10 to 20 mole % wherein the total diol content is 100 mole %; or
wherein the sum of the diol content of one or more diol monomer components capable of forming an amorphous component in the final polyester is from 15 to 20 mole % wherein the total diol content is 100 mole %; or
wherein the sum of the diol content of one or more diol monomer components capable of forming an amorphous component in the final polyester is from 15 to 25 mole % wherein the total diol content is 100 mole %.

13. The crystallizable film or the thermoformed film or sheet of claim 4, wherein the sum of the diol content of the residues of 1,4-cyclohexanedimethanol and neopentyl glycol in the final polyester is from 5 to 25 mole %, 5 to 15 mole %, 10 to 15 mole %, 10 to 20 mole %, or 5 to 20 mole %, or less than 20 but more than 5 mole % wherein the total diol content is 100 mole %; or
wherein said 1,4-cyclohexanedimethanol residues are present in the amount of 0 to about 10 mole %, diethylene glycol residues are present in the amount of 2 to 10 mole %, neopentyl glycol residues in the amount of 5 to 20 mole %, and ethylene glycol residues are present in the amount of 75 mole % or greater; or
wherein said 1,4-cyclohexanedimethanol residues are present in the amount of 2 to 5 mole %, diethylene glycol residues are present in the amount of 5 mole % or less, neopentyl glycol residues in the amount of 10 to 15 mole %, and ethylene glycol residues are present in the amount of greater than 75 mole %.

14. The crystallizable film or the thermoformed film or sheet of claim 4, wherein the crystallizable polyester component sum of the diol content of the residues of 1,4-cyclohexanedimethanol and neopentyl glycol in the final polyester is from 4 to 15 mole %, 1 to 25 mole %, or 2 to 20 mole %, or less than 20 but more than 2 mole % wherein the total diol content is 100 mole %.

15. The crystallizable film or the thermoformed film or sheet of claim 4, wherein said film or sheet is stretched in at least one direction and the stretched film or sheet has a strain induced crystalline melting point of 170° C. or greater; or wherein said film or sheet is stretched in at least one direction and the stretched film or sheet has a strain induced crystalline melting point of 200° C. or greater.

16. A method of introducing or establishing recycle content in a polyester produced by the process of claim 1 comprising:
a. obtaining a recycled monomer allocation or credit for at least one recycled monomer comprising TPA, EG, DMT, CHDM, NPG or DEG.
b. converting the recycled monomers in a synthetic process to make a polyester,
c. designating at least a portion of the polyester as corresponding to at least a portion of the recycled monomer allocation or credit, and optionally
d. offering to sell or selling the polyester as containing or obtained with recycled monomer content corresponding with such designation.

17. The process of claim 1, wherein the amount of recycled polyester added to the process is from 5-100% based on the amount of TPA required.

18. The process of claim 1, wherein the esterification catalyst comprises one or more of Mn, Ti, Zn, Co, Ge or Al.

19. The process of claim 1, wherein the polycondensation catalyst comprises one or more of Sn, Sb, Ti, Li/Al, Al, Ge, Pb, Zn, Co, Bi, Cd, Ca or Ni.

20. The process of claim 1, wherein the process further comprises adding a catalyst or additive via the addition of recycled polyester in which the catalyst or additive is a component of the recycled polyester; such as Sb, Ti, Co, Mn, Li, Al, P.
